(19) United States
(12) Patent Application Publication
(10) Pub. No.: US 2009/0214034 A1
(43) Pub. Date: Aug. 27, 2009

(54) Systems and methods for enabling electronic messaging with recipient-specific content

(76) Inventors: Rohit Mehrotra, Plano, TX (US); Neha Mehrotra, Plano, TX (US)

Correspondence Address: HANSRA PATENT SERVICES, 4525 GLEN MEADOWS PLACE, BELLINGHAM, WA, 98226, US

(21) Appl. No.: 12/072,686

(22) Filed: Feb. 26, 2008

(51) Int. Cl. H04L 9/00; G06F 15/16

(52) U.S. Cl. 380/255; 709/206

(57) ABSTRACT

The present invention is directed to a system and method for enabling electronic messaging with recipient-specific content, wherein multiple recipients may view non-private information and less than all recipients may view non-private information. In one embodiment, an author may select between two messaging processing algorithms to send messages to recipients, wherein one algorithm uses encryption and the other does not. In one embodiment, once private information is received by a recipient, its dissemination is automatically restricted. In one embodiment, the method of enabling messaging with recipient-specific content is transparent to email server machines. In one embodiment, HTML tags, comments and/or headers are used to mark information as private and to prevent such information from being viewed by unintended recipients. In one embodiment, non-private information is viewed by all recipients, but privately-highlighted non-private information is viewable by less than all recipients.

### FIELD OF THE INVENTION

The present invention relates generally to electronic messaging systems, such as email systems, text messaging systems, instant messaging systems and voicemail systems, among other things. More particularly, the present invention relates to systems and methods for enabling electronic messaging with recipient-specific content.

### BACKGROUND OF THE INVENTION

A significant amount of communication, both in business and personally, occurs through use of electronic messaging systems, such as email systems, text messaging systems, instant messaging systems and voicemail systems, among other things. In contrast to other forms of communication, such as paper mail systems, the development of electronic messaging systems has occurred relatively recently.

As electronic messaging systems have gained in widespread use, inefficiencies have been identified and certain new features have been found to be desirable in order to overcome such inefficiencies. One such feature is the ability to generate electronic messages with recipient-specific content.

For example, when composing a single email message that is being sent to multiple recipients, an author may want to include certain non-private information for all of the recipients, while also including certain private information for one or more recipients (i.e., a subset of the recipients). To the best of the inventors' knowledge, there is no commercially-implemented email messaging technique that allows an author to compose a single email message to meet the author's goal.

As another example, when composing a single email message that is being sent to multiple recipients, an author may also want to privately-highlight one or more sections of text, so that such text is only highlighted for one or more recipients. Again, to the best of the inventors' knowledge, there is no commercially-implemented email messaging technique that allows an author to compose a single email message to meet the author's goal.

Instead, to accomplish his goal, the author would be required to compose multiple email messages. More specifically, in the former example, the author would need to compose one email message to the recipient (or recipients) that was only to receive the non-private information, wherein such email message would only include the non-private information. The author would also need to compose another email message to the recipient (or recipients) that was to receive both the non-private information and the private information, wherein such email would include both the non-private information and the private information.

Furthermore, the problem may be compounded if there are multiple portions of private information that are each to be sent to different recipients (or groups of recipients). For example, in addition to sending non-private information to all recipients, the author may want to send a first portion of private information to a first recipient (or first group of recipients) and a second portion of private information to a second recipient (or second group of recipients), wherein the first and second recipients (or first and second groups of recipients) are not identical to one another, wherein the first and second recipients (or first and second groups of recipients) are a subset of the overall number of recipients, and wherein the first portion of private information is different from the second portion of private information.

In such case, the author would be required to compose at least three different email messages. More specifically, the author would need to compose a first email message to the recipient (or recipients) that was only to receive the non-private information, wherein such email message would only include the non-private information. The author would also need to compose a second email message to the recipient (or recipients) that was to receive both the non-private information and the first portion of private information, wherein such email would include both the non-private information and the first portion of private information. Finally, the author would also need to compose a third email message to the recipient (or recipients) that was to receive both the non-private information and the second portion of private information, wherein such email would include both the non-private information and the second portion of private information.

Attempts have been made to generate electronic messages with recipient-specific content. For example, U.S. Pat. No. 6,192,396 to Kohler (hereinafter “Kohler”), which is incorporated herein by reference, describes a computerized messaging system which authors messages that contain recipient-specific content, such that each recipient does not necessarily receive a message that is identical to all recipients. However, Kohler creates other inefficiencies.

More specifically, in the immediately prior example, if the first and second subsets of recipients included overlapping recipients, then such overlapping recipients would receive multiple email messages, each of which would include overlapping content (see, e.g., col. 11, lines 30-38 of Kohler). In view of the number of email messages that a typical person receives in a day, the technique described in Kohler is inefficient.

Furthermore, Kohler appears to describe an independent email client. Accordingly, Kohler requires downloading of an entirely new email client, instead of integrating with existing, well-established email clients (e.g., Outlook, Gmail, Yahoo Mail, AOL, Hotmail, Thunderbird, MacMail, etc.).

In addition, Kohler fails to discuss any technique for restricting the purposeful or accidental dissemination of private information when a recipient receives such information. For example, Kohler fails to discuss how to reduce the likelihood of accidentally disseminating private information when a recipient is forwarding or replying-to an email message that includes private information.

U.S. Pat. No. 6,636,965 to Beyda et al. (hereinafter “Beyda”), which is incorporated herein by reference, describes a message processing system that allows a user to create messages for delivery to a number of recipients. The user can create one or more comments or special instructions in the message that are to be delivered to fewer than all of the recipients of the common message. The comments are encrypted such that they cannot be accessed by all recipients of the message, but only selected recipients of the message. A message processor decrypts the comments (where appropriate) and includes them along with the common portion of the message prior to delivery to those recipients that are to receive the comments. Alternatively, a recipient of a common portion of a message selects an icon or other prompt indicating that a comment is attached to the message. The recipient is asked to enter a password or other security code that causes the messaging system to determine whether the recipient is to receive the comment and, if so, to decrypt the attached comment.

The message processing system in Beyda is a message server (e.g., an email message server) in which the main intelligence resides. Hence, it appears that the intelligence needs to be coded in all message servers that use the technique described in Beyda. As a matter of practicality, this is virtually impossible, since there are so many different parties that own and control message servers.

Furthermore, it appears that all email clients have to access the same message server in order to be able to retrieve the message. Again, this has limited practicality. For example, such a configuration might work in the case of a corporate email server or on a corporate PBX voicemail server. However, it is impractical when email is exchanged with individuals who do not work for the same organization or do not share the same message server. Accordingly, it would be desirable to develop a system and method that allowed delivery of recipient-specific messages between users that do not share the same message server.

U.S. Pat. No. 6,327,612 to Watanabe (hereinafter “Watanabe”), which is incorporated herein by reference, describes an electronic mail transmission system with selective file attachment. The mailing apparatus creates email destined for the TO addresses, each including the body text and the TO addresses, together with email destined for the CC/BCC addresses including the body text and the CC/BCC addresses. The mailing apparatus appends the attachment files to the email destined for the TO addresses, whereas it does not append the attachment files to the email destined for the CC/BCC addresses. Instead, it appends a message to the latter to indicate the attachment files have been attached to the email destined for the TO addresses.

Watanabe does not give an author of an email message an opportunity to include recipient-specific information in the body of the email message. Instead, it appears that the information included by the author in the body of the email message is sent to all of the recipients.

Furthermore, Watanabe appears to require modifications to be made to email servers. That is, the intelligence apparently needs to be coded in all message servers that use the technique described in Watanabe. As a matter of practicality, this is virtually impossible, since there are so many different parties that own and control message servers.

Despite the granting of the aforementioned patents, the inventions described in such patents have apparently not been commercially successful. As mentioned above, one reason for their lack of commercial success may be due to the various entities that control email servers and the need (in at least some cases) to modify such email servers to properly implement the inventions. Accordingly, it would be desirable to develop a system and method for enabling electronic messaging with recipient-specific content, which is transparent to email servers (i.e., does not necessarily require modifications to be made to the email server (back end)) and which includes intelligence at the client (front end).

It would also be desirable to provide a system and method for enabling electronic messaging with recipient-specific content that works across multiple email server platforms.

None of the aforementioned patents adequately describe techniques for automatically restricting or otherwise controlling the dissemination of private information once it has been received by a recipient. Therefore, it would be desirable to provide a system and method for enabling electronic messaging with recipient-specific content that automatically restricts or controls the dissemination of private information once it has been received by a recipient.

None of the aforementioned patents adequately describe how “white space” is eliminated in email messages, when private information is not delivered to a particular recipient. In fact, it is not clear whether areas of “white space” are included in email messages when private information is not delivered to a particular recipient. Therefore, it would also be desirable to provide a system and method of enabling electronic messaging with recipient-specific content that automatically eliminates “white space” corresponding to private information that is not being delivered to a particular recipient.

### SUMMARY OF THE INVENTION

The present invention is designed to address at least one of the aforementioned problems and/or meet at least one of the aforementioned needs.

Systems and methods for enabling electronic messaging with recipient-specific content are disclosed. In one embodiment, the present invention allows an author to compose a single message that is sent to multiple recipients, in which the author can include certain non-private information for all of the recipients and certain private information for one or more recipients (i.e., a subset of the recipients).

In one embodiment, the present invention enables electronic messaging with recipient-specific content, such that, once private information is received by a recipient, its dissemination is automatically restricted or controlled.

In one embodiment, the present invention enables electronic messaging with recipient-specific content, which is transparent to email server machines. In one embodiment, intelligent software associated with the invention is present on one or more client machines, but not necessarily on email server machines. In one embodiment, the intelligent software is downloaded to one or more client machines, which allows integration with existing an email client or webmail client. In one embodiment, the intelligent software is included as part of an email client or webmail client.

In one embodiment, the present invention enables electronic messaging with recipient-specific content, wherein such recipient-specific content is marked and/or hidden using hypertext markup language tags, comments and/or headers. In one embodiment, by hiding the recipient-specific content, “white space” formatting associated with the recipient-specific content is automatically reduced or eliminated.

In one embodiment, the present invention enables electronic messaging with recipient-specific content, wherein the recipient-specific content is encrypted and/or hidden from recipients who are not to view the recipient specific content. In one embodiment, encrypted recipient-specific content is decrypted for a recipient that is to view the recipient-specific content; however, a password is not required to decrypt such recipient-specific content. In one embodiment, a second message is sent to a recipient receiving private information, wherein such second message includes the private information in unencrypted form.

In one embodiment, the present invention enables electronic messaging with recipient-specific content, wherein the recipient-specific content includes an identical portion of text for all recipients, but the text is highlighted (or otherwise made distinguishable) for less than all of the recipients.

In one embodiment, the present invention enables electronic messaging with recipient-specific content, wherein an author may select between two messaging processing algorithms. In one embodiment, a first of the two message processing algorithms uses encryption and a second of the two message processing algorithms does not use encryption.

Other objects, features, embodiments and advantages of the invention will be apparent from the following specification taken in conjunction with the following drawings.

### BRIEF DESCRIPTION OF THE DRAWINGS

FIG. 1 is a simplified diagrammatic representation of an exemplary electronic messaging system;

FIG. 2 is a simplified diagrammatic representation of a single message to be composed by an author, wherein such message includes recipient-specific content;

FIG. 3 is a diagrammatic representation of a graphical user interface (email editor window) for a client machine, wherein mail header information has been completed and wherein the body of the message has been entered;

FIG. 4 is a diagrammatic representation of a dialog box for a client machine, which allows an author to select between two message processing algorithms for sending a message with recipient-specific content;

FIG. 5 is a diagrammatic representation of a Mark Private dialog box, which allows private information to be associated with specific recipients;

FIG. 6 is a diagrammatic representation of an email editor window, which illustrates an email message with portions of non-private information, portions of private information and portions of privately-highlighted non-private information;

FIG. 7 is a diagrammatic representation of a Manage Private dialog box, which provides a preview of the private information and privately-highlighted non-private information associated with each recipient based on each portion of private information or privately-highlighted non-private information;

FIG. 8 is a diagrammatic representation of a preview window, wherein a preview of an exemplary email message to be sent to User1 is shown;

FIG. 9 is a diagrammatic representation of a preview window, wherein a preview of an exemplary email message to be sent to User2 is shown;

FIG. 10 is a diagrammatic representation of a preview window, wherein a preview of an exemplary email message to be sent to User3 is shown;

FIG. 11 is a diagrammatic representation of a preview window, wherein a preview of an exemplary email message to be sent to User4 is shown;

FIG. 12 is a diagrammatic representation of a preview window, wherein a preview of an exemplary email message to be sent to User5 is shown;

FIG. 13 is a diagrammatic representation of a preview window, wherein a preview of an exemplary email message to be sent to User6 is shown;

FIG. 14 is a diagrammatic representation of a received message window, which shows an exemplary message received by User1;

FIG. 15 is a diagrammatic representation of a received message window, which shows an exemplary message received by User2;

FIG. 16 is a diagrammatic representation of a received message window, which shows an exemplary message received by User3;

FIG. 17 is a diagrammatic representation of a received message window, which shows an exemplary message received by User4;

FIG. 18 is a diagrammatic representation of a received message window, which shows an exemplary message received by User5;

FIG. 19 is a diagrammatic representation of a received message window, which shows an exemplary message received by User6;

FIG. 20 is a diagrammatic representation of a portion of an author's sent messages folder, which lists email messages sent to recipients;

FIG. 21 is a diagrammatic representation of a warning dialog box, which shows an exemplary warning message when a recipient attempts to forward or reply-to an email message that includes private information;

FIG. 22 is a diagrammatic representation of a warning dialog box, which shows an exemplary warning message when a recipient attempts to forward or reply-to an email message that includes privately-highlighted non-private information;

FIG. 23 is a diagrammatic representation of a message body, wherein the recipient has selected to forward or reply-to the message by including private information and deleting privately-highlighted non-private information;

FIG. 24 is a diagrammatic representation of a message body, wherein the recipient has selected to forward or reply-to the message by deleting private information and keeping the privately-highlighted non-private information;

FIG. 25 is a diagrammatic representation of an email editor window, wherein the recipient has selected to reply-to-all recipients of the original email message, wherein the recipient has decided to delete the private information before the reply is sent and wherein the recipient has decided to keep privately-highlighted non-private information;

FIG. 26 is a diagrammatic representation of a Yahoo® compose-window toolbar with certain icons seamlessly integrated therein;

FIG. 27 is a diagrammatic representation of an Internet Explorer® toolbar with certain icons seamlessly integrated therein;

FIG. 28 is a diagrammatic representation of a Sending Options dialog box, which provides an author with options as to how private information will be handled when a recipient forwards or replies-to an email message composed by the author;

FIG. 29 is a diagrammatic representation of a received message window, which shows an exemplary message received by User1;

FIG. 30 is a diagrammatic representation of a received message window, which shows an exemplary message received by User2;

FIG. 31 is a diagrammatic representation of a received message window, which shows an exemplary message received by User3;

FIG. 32 is a diagrammatic representation of a received message window, which shows an exemplary message received by User4;

FIG. 33 is a diagrammatic representation of a received message window, which shows an exemplary message received by User5;

FIG. 34 is a diagrammatic representation of a received message window, which shows an exemplary message received by User6;

FIG. 35 is a diagrammatic representation of a portion of an author's sent messages folder, which lists email messages sent to recipients;

FIG. 36 is a diagrammatic representation of a received message window, which shows an exemplary second email message sent to User6, wherein such second message includes unencrypted private information for User6;

FIG. 37 is a diagrammatic representation of a received message window, which shows an exemplary second email message sent to User1, wherein such second message includes a notification that privately-highlighted non-private information has been sent to User1; and,

FIG. 38 is a diagrammatic representation of an email editor window, wherein the recipient has selected to reply-to-all recipients of the original email message, wherein the recipient has decided to keep the private information before the reply is sent and wherein the recipient has decided to unhighlight the privately-highlighted non-private information.

### DETAILED DESCRIPTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspects of the invention to the embodiments illustrated.

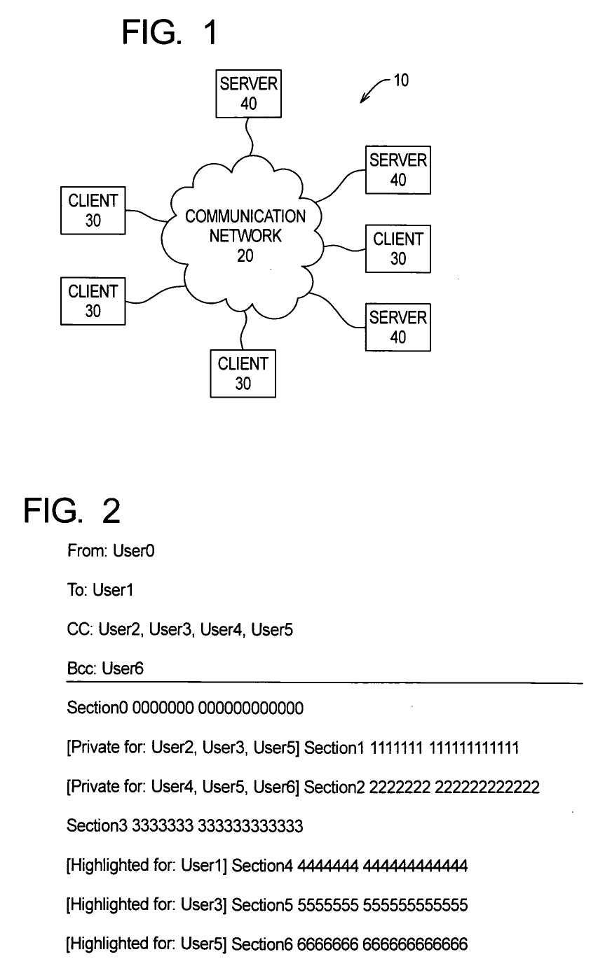

FIG. 1 illustrates a simplified and exemplary electronic messaging system 10, which includes a communication network 20, one or more client machines 30 and one or more server machines 40. The communication network 20 allows the client machines 30 and server machines 40 to communicate with each other.

Depending on the type of electronic messaging system 10 (e.g., an email system, voicemail system, etc.), the communication network 20 may include, for example, a wide area network (e.g., the Internet), a local area network, a metropolitan area network, a digital mobile telephony system, an integrated services digital network (“ISDN”), a data leased circuit, a telephone circuit or a combination thereof. The communication network 20 may be completely public, completely private or partly private. Generally, there is no limitation as to the type of communication network that can be used, so long as the communication network 20 permits the transmission of electronic data.

A client application (or client applications) runs on a client machine 30 and a server application (or server applications) runs on a server machine 40. In the field of information technology, the term client is an application or system that accesses a remote service on another computer system, known as a server machine, by way of a network. It should be understood that the term client is interchangeably used to refer to such an application (or applications) running on a client machine 30 and the client machine 30 itself. Likewise, the term server is interchangeably used to refer to an application (or applications) running on a server machine 40 and the server machine 40 itself. One skilled in the art will understand the appropriate meaning to be given to such terms in the context of the present application.

Server machines 40 run software that allow them to provide one or more services, such as being a Web server, an email server and/or a file transfer protocol (“FTP”) server. In the case that the server 40 is an email server, data is generally transferred according to a simple mail transfer protocol (“STMP”), extended simple mail transfer protocol (“ESTMP”), internet message access protocol (“IMAP”) or any other mail transferring protocol. Of course, it is understood that mail transfer protocols will continue to evolve and the invention is not limited to the current state of mail transfer protocols.

For ease of understanding, the electronic messaging systems and methods of the present invention will be described with reference to email systems. As will be understood by those skilled in the art, the present invention is equally applicable to other types of electronic messaging systems, such as text messaging systems, instant messaging systems, short message service (“SMS”) systems and voicemail systems, among other things.

The present invention enables electronic messaging with recipient-specific content in a multi-recipient email. Several embodiments of the invention are described herein. Among other things, the inventors have developed two message processing algorithms. The inventors have termed one message processing algorithm “SplitEmail” and have termed the other message processing algorithm “BccTag,” where the SplitEmail message processing algorithm does not use encryption and the BccTag message processing algorithm uses encryption.

It should be understood that some embodiments of the invention may include one or more of the features of the SplitEmail and/or BccTag message processing algorithms. It should also be understood that some embodiments of the invention may include neither the SplitEmail nor the BccTag message processing algorithms. It should also be understood that there are several different embodiments of the SplitEmail message processing algorithm and several different embodiments of the BccTag message processing algorithm.

The SplitEmail and BccTag message processing algorithms both include software, which allows an author to compose an email message that contains recipient-specific information in a multi-recipient email, such that each recipient can view portions of the email message that is only intended for them.

More specifically, an author of an email message may mark a portion of an email message as private for a specific recipient (private information). The email message may also include a portion which is to be viewed by all recipients (non-private information). Both the SplitEmail and BccTag message processing algorithms ensure that a recipient that is to view certain private information is able to view such private information, along with non-private information, and that a recipient that is to view only non-private information can view such non-private information, but not any private information.

An overview will be provided for certain embodiments of the SplitEmail message processing algorithm, followed by an overview of certain embodiments of the BccTag message processing algorithm. An overview will also be provided for an additional feature of the invention, which has been termed “EmailHighlighter” by the inventors.

Subsequently, details will be provided for additional embodiments of the BccTag and SplitEmail message processing algorithms, along with additional embodiments of the EmailHighlighter feature.

### Overview of the SplitEmail Message Processing Algorithm

In connection with the SplitEmail message processing algorithm, an author composes a message using software known as SplitEmail Writer, which is downloaded to a client machine 30 being used by the author. SplitEmail Writer integrates with an email client on the client machine 30 or integrates with a webmail client that the author accesses through the Internet via the client machine 30. Among other things, SplitEmail Writer integrates with an email editor that is included with the email client (or webmail client).

The author composes a message in an email editor window and associates various sections of the message with different recipients. When the author has finished composing the message and indicates that it is to be sent (e.g., by selecting a Send icon), SplitEmail Writer analyzes the message based upon the sections that have been associated with the various recipients. Then, using information obtained from the analysis, SplitEmail Writer composes and sends separate email messages to each recipient, such that the separate email messages include the portions of the author's message that were intended for each recipient. The email messages are sent to the recipients using standard protocols (e.g., SMTP, ESMTP, IMAP or any other mail transferring protocol used by the author's email client).

Effectively, SplitEmail Writer “splits-up” the author's original message based upon the various portions of private information that are to be delivered to the various recipients, along with the various portions of non-private information that are to be delivered to all recipients. Then, SplitEmail Writer “recomposes” the author's original message to send the appropriate portions of the message to the appropriate recipients. Thus, for a particular recipient, SplitEmail Writer essentially “strips out” the private information from the author's original message that is not intended for the recipient. Due to the recomposition of the author's original message by SplitEmail Writer, when the email message is viewed by the recipient, it does not include sections of white space where private information was not included.

In order to ensure that private information is not accidentally forwarded by a recipient through use of a “reply to all” response, mail headers are adjusted by SplitEmail Writer prior to sending email messages that include private information. That is, except for the email address of the author, non-confidential mail headers are placed in the body of the email message. The email address of the author remains in the “From:” section of the non-confidential mail header.

By doing so, a recipient is able to see the email addresses of the non-confidential recipients of the message. However, the recipient cannot accidentally forward private information to a recipient that did not receive such private information by, for example, accidentally “replying to all.”

As further explanation, non-confidential mail headers include email addresses of both recipients to whom email is directed (“To:” section of mail header) and recipients who are indicated as receiving a courtesy copy of the message (“Cc:” section of mail header). Conventionally, the email addresses of non-confidential recipients are included in the non-confidential mail headers of a received email message. In contrast, a confidential mail header is for recipients who receive a blind courtesy copy of an email message (“Bcc:” section of mail header). Confidential mail headers conventionally list email addresses of the confidential recipient(s) when composing a message (i.e., in the email editor), but the email address of each confidential recipient is not viewable by anyone except the particular confidential recipient of the message.

When a recipient receives an email message, the recipient is requested to download an optional reader called SplitEmail Reader, which is software that is downloaded to a client machine 30 being used by the recipient. SplitEmail Reader integrates with an email client on the client machine 30 or integrates with a webmail client that the author accesses through the Internet via the client machine 30. It is contemplated that SplitEmail Reader will be made available for free downloading via the Internet or will come integrated with one or more email clients (e.g., Outlook, Gmail, Yahoo Mail, AOL, Hotmail, Thunderbird, MacMail, etc.).

If SplitEmail Reader is installed on the client machine 30 being used by the recipient, SplitEmail Reader will issue a warning to the recipient if the recipient tries to forward or reply-to an email message that includes private information. In addition, the recipient will be given the option to automatically delete the private information whenever the recipient tries to forward or reply-to the message. If such option is selected, SplitEmail Reader will perform such automatic deletion prior to forwarding or replying-to the message.

If SplitEmail Reader is not installed, the recipient can forward the private information that recipient has received. However, this is no different from a recipient receiving a private message that the recipient decides to forward to others.

### Overview of the BccTag Message Processing Algorithm

In connection with the BccTag message processing algorithm, an author composes a message using software known as BCCTag Writer, which is downloaded to the client machine 30 being used by the author. BccTag Writer integrates with an email client on the client machine 30 that is being used by the author or with a webmail client that the author accesses through the Internet via the client machine 30. Among other things, BccTag Writer integrates with an email editor that is included with the email client (or webmail client).

The author composes a message using an email editor window and associates various sections of the message with different recipients. When the author has finished composing the message and indicates that it is to be sent (e.g., by selecting a Send icon), BccTag Writer analyzes the message based upon the sections that have been associated with the various recipients. Then, using information obtained from the analysis, BccTag Writer encrypts the private information and then hides the encrypted private information before sending email messages having an identical message body to all of the recipients. The email messages are sent to the recipients using standard protocols (e.g., SMTP, ESMTP, IMAP or any other mail transferring protocol used by the author's email client).

The private information is encrypted using an encryption algorithm with a specific key and a counter key, wherein the counter key is the email address of the recipient that is associated with the private information. The counter key may be obtained from the mail header or through information provided via standard email protocols (e.g., SMTP, ESMTP, IMAP or any other mail transferring protocol used by the author's email client). The encrypted private information is hidden using hypertext markup language (“HTML”) comments or HTML tags. Of course, extended HTML (“XHTML”) comments or XHTML tags may also be used. Furthermore, comments and tags from other derivatives of HTML or XML may also be used.

In order for a recipient to read an email message composed using BccTag Writer, a recipient downloads software known as BCCTag Reader to the client machine 30 that the recipient is using. BccTag Reader integrates with the email client on the client machine 30 being used by the recipient or with the webmail client that the recipient accesses through the Internet via the client machine 30. Generally, the recipient can only view the confidential parts if BccTag Reader is installed. If BccTag Reader is not installed, the recipient will see the non-private information but not the private information. It is contemplated that BccTag Reader will be made available for free downloading via the Internet or will come integrated with one or more email clients (e.g., Outlook, Gmail, Yahoo Mail, AOL, Hotmail, Thunderbird, MacMail, etc.).

In order to account for circumstances where a version of BccTag Reader may not yet be available or is not easily downloadable by a client machine (e.g., in mobile telephone applications, certain Unix-based machines, Macintosh-based operating systems, etc.), a technique is required to inform the recipient that private information has been sent to the recipient and/or that the recipient needs to download BccTag Reader. In such case, as described above, BccTag Writer automatically sends the aforementioned encrypted email to all of the recipients. However, BccTag Writer also sends a second email message to each of the recipients of private information, in unencrypted form, which includes the private information associated with each particular recipient, but not the non-private information. Since the confidential text is unencrypted, it can be viewed on any email client including, for example, handhelds. The second email message also advises the recipient to download the reader to see the private information in the correct context (i.e., the private information as it is appropriately placed relative to the non-private information). Once the recipient has downloaded BccTag Reader, then the recipient may ignore the second email. Alternatively (or in addition), BccTag Reader may automatically delete the second email.

In one embodiment, the author may restrict the recipient from forwarding or replying-to an email composed using BccTag Writer. In another embodiment, the author may permit the recipient to forward or reply-to an email message composed using BccTag Writer, but the recipient's private information (or all of the private information) will be automatically deleted before the email message is forwarded or replied-to. In yet another embodiment, the author may permit the recipient to forward or reply-to an email message composed using BccTag Writer, but will keep the recipient's private information (and other private information) encrypted. In yet a further embodiment, the author may permit the recipient to forward or reply-to an email message composed using BccTag Writer, but will turn the recipient's private information into non-private information, such that it is viewable by the party to whom the message is being sent. In another embodiment, with respect to forwarding or replying-to an email message composed using BccTag Writer, the author will allow the recipient to decide from among one or more of the above options.

### Overview of EmailHighlighter Feature

According to the EmailHighlighter feature, an author associates one or more sections of text with one or more recipients, as in the case of the SplitEmail and BccTag message processing algorithms. However, none of the text is hidden from the other recipients. Instead of hiding the associated sections of text from non-intended recipients, generally, all of the text will be viewable by all of the recipients. However, text associated with a particular recipient (or groups of recipients) will be highlighted for such recipient, but such text will not be highlighted when received by other recipients (or groups of recipients). Thus, EmailHighlighter permits the author to focus a recipient's attention on a portion (or portions) of an email message. For purposes of this application, such text that is highlighted by EmailHighlighter is called privately-highlighted non-private information.

The EmailHighlighter feature may be included as part of the software for SplitEmail Writer and/or SplitEmail Reader or as part of the software for BccTag Writer and/or BccTag Reader. As another option, software known as EmailHighlighter Writer may be downloaded to a client machine 30 being used by the author and software known as EmailHighlighter Reader may be downloaded to a client machine 30 being used by the recipient.

EmailHighlighter Writer integrates with an email client on the client machine 30 or integrates with a webmail client that the author accesses through the Internet via the client machine 30. Among other things, EmailHighlighter Writer integrates with an email editor that is included with the email client (or webmail client). Similarly, EmailHighlighter Reader integrates with an email client on the client machine 30 or integrates with a webmail client that the recipient accesses through the Internet via client machine 30.

Either one or both of SplitEmail Writer and BCCTag Writer may be installed on the author's client machine. For purposes of explaining SplitEmail and BCCTag, it is assumed that both SplitEmail Writer and BCCTag Writer are installed on the client machine being used by the author.

As shown in FIG. 2, User 0 (the author) is composing a message that is to be sent to User1, wherein a courtesy copy is to be sent to User2, User3, User4 and User5, and wherein a blind courtesy copy is to be sent to User6. The message includes seven sections comprising Section 0, Section 1, Section 2, Section 3, Section 4, Section 5 and Section 6.

Section 0 is non-private information and is to be viewed by all recipients (i.e., User1, User2, User3, User4, User5 and User6). Section 1 is private information and is only to be viewed by User2, User3 and User5. Section 2 is private information and is only to be viewed by User4, User5 and User6. Section 3 is non-private information and is to be viewed by all recipients. Section 4 is non-private information that is to be viewed by all recipients, but is highlighted only for User1. Section 5 is non-private information that is to be viewed by all recipients, but is highlighted only for User3. Section 6 is non-private information that is to be viewed by all recipients, but is highlighted only for User5.

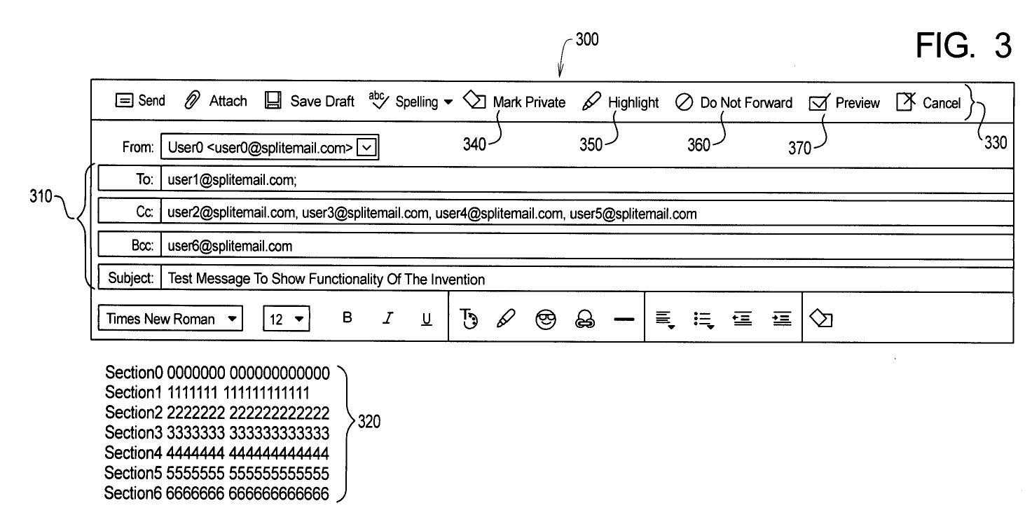

FIG. 3 is a diagrammatic representation of a graphical user interface (email editor window) 300 for a client machine. As shown in FIG. 3, the author (User 0) composes a message by completing email header information 310 (including the “To:”, “Cc:” and “Bcc:” sections) to the designated recipients set forth in FIG. 2. The author also completes the body of the message 320, which includes both the private information and the non-private information described in FIG. 2. The author may complete the email header information and body of the message by inputting data on the author's client machine 30 using a keyboard, a microphone, a mouse, a touchpad and/or other well-known techniques.

As shown at the top of FIG. 3, an email editor toolbar 330 includes icons with the standard options to Send, Attach, Save Draft, check Spelling and Cancel. The email editor toolbar also includes icons with the additional options to Mark Private 340, Highlight 350, Do Not Forward 360 and Preview 370, as will be described in further detail below. The exemplary additional options are seamlessly integrated into a standard email editor toolbar, after being downloaded as part of (in this case) the SplitEmail Writer.

In order to mark the information in Section 1 as private, the author selects the text associated with Section 1 (e.g., by depressing a mouse's left-click button at the beginning of the relevant text, dragging the mouse across the relevant text, and then releasing the mouse's left-click button). The selected text is highlighted (or somehow shown as being selected by appearing differently than unselected text) and then the author selects the Mark Private icon 340 from the toolbar (e.g., by depressing a mouse's left-click button while the cursor/arrow is over the Mark Private icon).

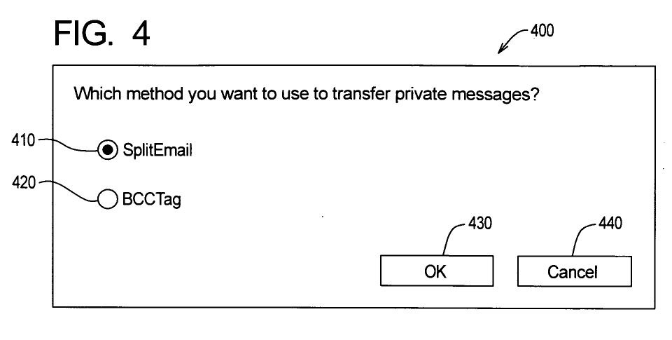

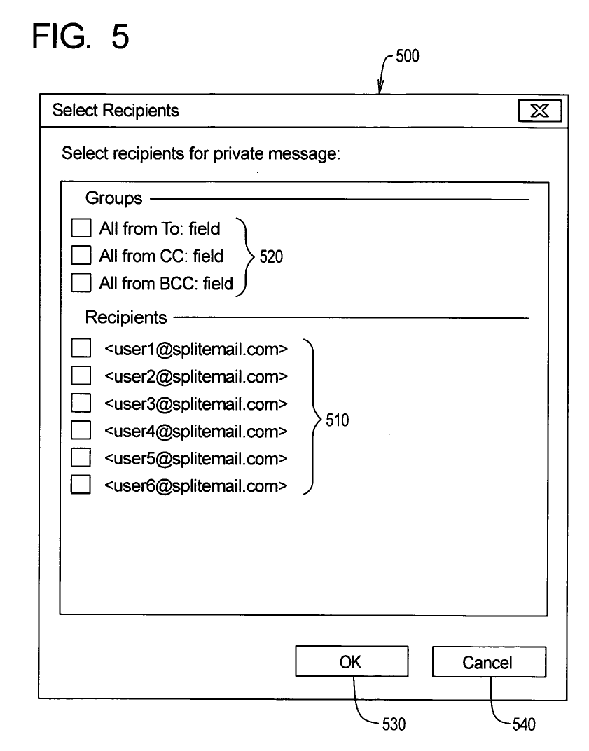

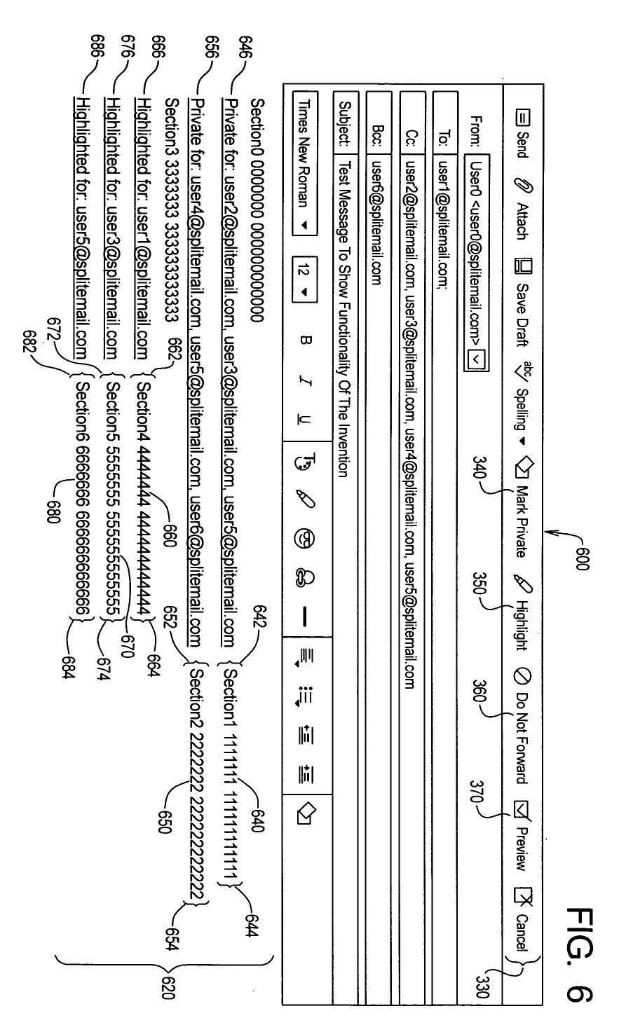

FIG. 4 is a diagrammatic representation of a transport mode dialog box 400 for a client machine 30, which allows the author to select between using a SplitEmail message processing algorithm or a BCCTag message processing algorithm to send a message with recipient-specific content. In FIG. 4, the author has selected to send a message using a SplitEmail message processing algorithm via SplitEmail radio button 410 (e.g., by depressing a mouse's left-click button while the cursor/arrow is over the radio button), as opposed to selecting a BccTag message processing algorithm via BccTag radio button 420. After selecting the OK button 430, a mark private dialog box 500 will appear, as shown in FIG. 5. If the author accidentally selected the Mark Private icon 340, changed his mind or wanted to cancel the process for any other reason, the author could click Cancel button 440, which would return the author to the email editor window 300.

It should be noted that the opportunity to select between message processing algorithms is optional, as an author may download a single message processing algorithm instead of multiple message processing algorithms. Furthermore, the opportunity for an author to select a particular message processing algorithm does not necessarily have to occur after the author has selected the Mark Private icon 340 from the toolbar 330. Instead, for example, the author can select the message processing algorithm prior to composing an email message. In addition, once selected, the message processing algorithm may serve as a default, until the author selects a different message processing algorithm.

As another option, selection of a message processing algorithm (see FIG. 4) occurs after the Send icon is selected. In such case, the mark dialog box 500 (see FIG. 5) may appear immediately after selection of the Mark Private icon 340 or the Highlight icon 350.

In one embodiment, the various options for message processing algorithms may be included as icons on a different toolbar (see, e.g., FIG. 27).

Returning to FIG. 5, the mark private dialog box 500 includes a list of recipients 510 that is populated by the email header information 310 entered by the author (see FIG. 3). The author has the option of selecting from among one or more group of recipients 520 (e.g., all recipients in the “To:” field, all recipients in the “Cc:” field and/or all recipients in the “Bcc:” field) and/or selecting from among individual recipients 510 by choosing the checkboxes associated with the appropriate selection.

In the present example, Section 1 is to be marked private for User2, User3 and User5. Therefore, the checkboxes associated with User2, User3 and User5 should be selected by the author. This can be accomplished by moving the cursor/arrow over the appropriate checkboxes and left-clicking the mouse.

Instead, the author can choose the checkbox associated with “All from Cc: field,” which will automatically cause checkmarks to appear in the checkboxes next to the email addresses associated with User2, User3, User4 and User5. The author would then deselect User4 by moving the cursor/arrow over the checkbox associated with User4 and then left-clicking the mouse. This would have the effect of also deselecting the checkbox associated with “All from Cc: field.” However, the selection of the checkboxes associated with User2, User3 and User5 would be retained.

Deselection of checkboxes may also be used if a recipient's email address is accidentally selected or if the author changes his mind with respect to sending the email to a particular recipient.

Once the recipients have been appropriately selected for a particular portion of private information, the author selects the OK button 530 and is returned to the email editor window 300. (As an aside, the OK button 530 is shown in phantom in FIG. 5, since no recipients have been selected). If the author changed his mind or wanted to cancel the process for any other reason, the author would select the Cancel button 540, which would return the author to the email editor window 300 without the selected text being changed to private information.

After a particular portion/section of private information (e.g., Section 1) has been associated with recipients, the author may mark the next portion/section of private information (e.g., Section 2). In order to mark the information in Section 2 as private, the author selects the text associated with Section 2. The selected text is highlighted (or somehow shown as being selected by appearing differently than unselected text) and then the author selects the Mark Private icon 340 from the toolbar 330. Another mark private dialog box 500 will appear, like the one shown and described in connection with FIG. 5.

In the present example, Section 2 is to be marked private for User4, User5 and User6. Therefore, User4, User5 and User6 should be selected by the author from the list of recipients 510. This can be accomplished by selecting the appropriate checkboxes associated with the recipients.

If a recipient is added after the author has composed a message 320 like that found in FIG. 3, the next time that the Mark Private icon 340 is selected, the list of recipients 510 in the mark private dialog box 500 will automatically updated to include the added recipient. For example, the author may add a new recipient after Section 1 has been marked private and then may decide to mark a new section private. After the author selects the new section of text and selects the Mark Private icon 340 from the toolbar, a new mark private dialog box 500 will appear (see, e.g., FIG. 5), which will include the name of the added recipient (along with the other recipients) in the list of recipients 510.

Returning to FIG. 3, the author may highlight text for a particular recipient (or group of recipients) of an email message. In one embodiment, only non-private information may be highlighted. In another embodiment, non-private information and/or private information may be highlighted.

In the example of FIG. 2, Section 4 will be highlighted when received by User1, but will not be highlighted when received by all of the other recipients. In order to mark the information in Section 4 for private highlighting, the author selects the text associated with Section 4. The selected text is highlighted (or somehow shown as being selected by appearing differently than unselected text) and then the author selects the Highlight icon 350 from the toolbar. A mark private dialog box 500 will appear. Accordingly, in the present example, User1 would be selected by the author from the list of recipients by choosing the appropriate checkbox.

In the example described in connection with FIG. 2, Section 5 is to be privately highlighted when received by User3 and Section 6 is to be privately highlighted when received by User5. The method of selecting such text for private highlighting should now be clear in view of the above description.

After the appropriate portions have been marked private and/or marked for private highlighting for the appropriate recipients, the author selects the OK button and the email editor window 600 appears. FIG. 6 illustrates an email editor window 600, which is similar to email editor window 300. However, in FIG. 6, the body of the message 620 is different from the body of the message 320 in FIG. 3 in order to indicate which portions of the message have been marked as private information (and/or privately-highlighted non-private information) and to indicate who the designated recipients are for such portions of the message. (As will be understood, the email editor window 600 will gradually appear like that shown in FIG. 6, as private information and/or privately-highlighted non-private information are designated for particular recipients.) Specifically, in the example shown in FIG. 6, the body of the message 620 includes first portion of private information 640 (e.g., Section 1), second portion of private information 650 (e.g., Section 2), first portion of privately-highlighted non-private information 660 (e.g., Section 4), second portion of privately-highlighted non-private information 670 (e.g., Section 5) and third portion of privately-highlighted non-private information 680 (e.g., Section 6). Indicia 642, 644, 652, 654, 662, 664, 672, 674, 682, 684 are used to identify the beginning and end of respective portions of private information 640, 650, 660, 670, 680. That is, open bracket 642 indentifies the beginning of the first portion of private information 640 and closed bracket 644 identifies the end of the first portion of private information 640. Open brackets and closed brackets are similarly provided for the remaining portions of private information or privately-highlighted information. It should be understood that the identifying indicia (e.g., 642, 644) may take on a variety different forms and are not limited to the types of brackets shown in FIG. 6. For example, the indentifying indicia may include other types of brackets, shading, highlighting, italicizing, and/or underlining, among other things.

Furthermore, the body of the message 620 also includes information 646, 656, 666, 676, 686 which respectively indicates the designated recipients for the first portion of private information 640, the second portion of private information 650, the first portion of privately-highlighted non-private information 660, the second portion of privately-highlighted non-private information 670 and the third portion of privately-highlighted non-private information 680. In FIG. 6, the information 646, 656, 666, 676, 686 is underlined, and includes the language “Private for:” prior to the respective email addresses of the designated recipients associated with each portion of private information 640, 650 and the language “Highlighted for:” prior to the respective email addresses of the designated recipients associated with each portion of privately-highlighted non-private information 660, 670, 680. That is, information 646 includes the language “Private for: user2@splitemail.com, user3@splitemail.com user5@splitemail.com” and information 656 includes the language “Private for: user4@splitemail.com, user5@splitemail.com, user6@splitemail.com”. Likewise, information 666 includes the language “Highlighted for: user1@.splitemail.com”, information 676 includes the language “Highlighted for: user3@splitemail.com” and information 686 includes the language “Highlighted for: user5@splitemail.com”.

It should be understood that the information indicating the designated recipients 646, 656, 666, 676, 686 does not necessarily need to be underlined, nor does it necessarily need to include the above-quoted language. Instead, the information indicating the designated recipients 646, 656, 666, 676, 686 may take on a variety different forms including, for example, being bracketed, shaded, highlighted, italicized, and/or bolded, among other things, and may use different language (e.g., “P for:” or “H for:”).

In addition, to more easily distinguish between various portions of private information or privately-highlighted non-private information, different types of shading, text color, highlighting or the like may be used. For example, in FIG. 6, first portion of private information 640, identifying indicia 642, 644 and information indicating the designated recipients 646 of the first portion of private information may all have a text color of red, while second portion of private information 650, indentifying indicia 652, 654 and information indicating the designated recipients 656 of the second portion of private information may all have a text color of blue. Furthermore, the first, second and third portions of privately-highlighted non-private information may all have text colors that are different from one another and different from the first and second portions of private information.

Once text has been marked private (e.g., Section 1 and/or Section 2) or has been marked for private highlighting (e.g., Section 4, Section 5 and/or Section 6), an author may select a Manage Private icon (not shown) from an email editor toolbar 330 like the one shown in FIG. 6. As another option, the author may select the text that has been marked private or for private highlighting (e.g., by double-clicking on same). As yet another option, the author may select the Mark Private icon 340 without selecting any text. In such case, the Mark Private icon 340 will have a dual function.

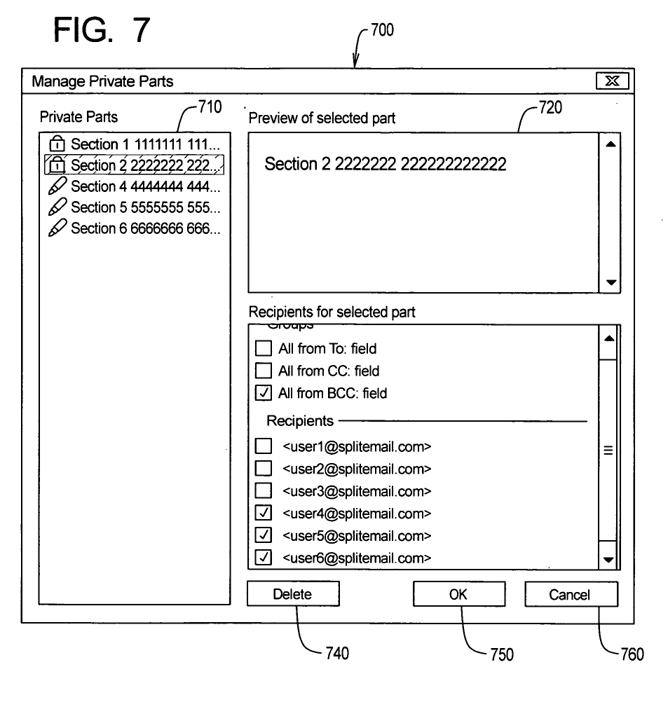

Subsequently, a Manage Private dialog box 700 will appear, as shown in FIG. 7. From the Manage Private dialog box 700, an author can edit a section of private or privately-highlighted information, add or remove recipients associated with a particular section of private or privately-highlighted information, or delete an entire section of private or privately-highlighted information.

The Manage Private dialog box 700 includes private parts selection box 710, private parts preview box 720 and selected recipients box 730. In private parts selection box 710, each portion of private information (e.g., Section 1 and Section 2) and privately-highlighted information (e.g., Section 4, Section 5 and Section 6) is listed on a separate line. Furthermore, private information includes a lock icon adjacent thereto, while privately-highlighted non-private information includes a highlighter icon adjacent thereto.

If a particular portion of private information or privately-highlighted non-private information has a character length that is longer than the character length of the private parts selection box 710, then less than the entirety of the portion of private information or privately-highlighted non-private information will be shown in the private parts selection box 710. For example, less than the entirety of Section 2 is shown in the second line of the private parts selection box 710.

Private parts preview box 720 is provided to allow an author to see the entirety of the text of a portion of private information or privately-highlighted information. In order to do so, the author selects one of the portions of private information or privately-highlighted information listed in the private parts selection box 710. As a default, the first-listed portion of private information (e.g., Section 1) or privately-highlighted information may be automatically selected in private parts preview box 720. Accordingly, as a default, the entirety of the first-listed portion of private information or privately-highlighted information would be viewable in the private parts preview box 720.

In FIG. 7, the author has selected Section 2, as indicated by the highlighting of Section 2 in the private parts selection box 710. Since Section 2 has been selected, the entirety of Section 2 appears in private parts preview box 720. It should be understood that, if the text associated with a particular portion of private information is lengthy, the author may need to scroll down to view the text. Nevertheless, the entire text is made viewable (and, therefore, accessible) in the private parts preview box 720.

An author may edit a particular portion of private information or highlighted information using the private parts preview box 720. For example, the author could edit Section 2 (e.g., by adding, removing and/or replacing text). After the text was edited, such text would appear in the email editor window 600 at such time that the email editor window 600 was next viewed.

In one embodiment, an author can also add a new portion of private information. In such embodiment, an Add icon would be placed in the Manage Private dialog box. For example, the Add icon might appear next to the Delete icon. In such case, the Manage Private dialog box may need to be reproportioned to enhance the aesthetics thereof.

The selected recipients box 730 notifies the author of the recipients who are presently designated to receive a particular portion of private information or highlighted information. In FIG. 7, Section 2 has been selected in the private information selection box 710. The checkboxes in the selected recipients box indicate that User 4, User 5 and User 6 are the recipients who are presently designated to receive the Section 2 portion of private information. It should be note that the checkbox associated with “All from Bcc: field” has been checked, since User 6 comprises all of the Bcc: recipients.

From the selected recipients box 730, the author can add or remove recipients associated with a particular section of private information or privately-highlighted information. This is simply performed by respectively selecting or deselecting the checkbox associated with a recipient (or group of recipients). Depending upon the total number of recipients, the author may need to scroll down to view certain recipients.

From the Manage Private dialog box 700, an author can delete an entire section of private information or privately-highlighted information using Delete button 740. Specifically, after selecting a particular portion of private information or privately-highlighted information using the private information selection box 710, the author selects the Delete button 740. Optionally, an additional dialog box may appear, which may warn the author that he is about to delete text and which may request confirmation before such text is deleted.

Once the author has made the aforementioned types of changes to the various portions of private information, the author selects the OK button 750 to accept such changes. If the author has changed his mind, wants to revert to the text of the portion of private information or highlighted information before editing, wants to revert to the designated recipients before editing, or otherwise wants to cancel the process, then the author selects the Cancel button 760.

In one embodiment, selecting the Cancel button 760 after selecting the Delete button 740 will not result in the deleted portion of private information or highlighted information to revert to an undelete state. In one embodiment, the opposite is true.

In one embodiment, an author can make changes to the various portions of private information or privately-highlighted information without having to individually select each portion of private information or privately-highlighted information that is to be changed. For example, the author can select Section 1 and make the aforementioned types of changes thereto (e.g., edit text, edit recipients, etc.). Then, the author can select Section 2 and make the aforementioned types of changes thereto, without having to select the OK button 750. Accordingly, the author can affectively “toggle” between the various portions of private information or privately-highlighted information and make changes thereto.

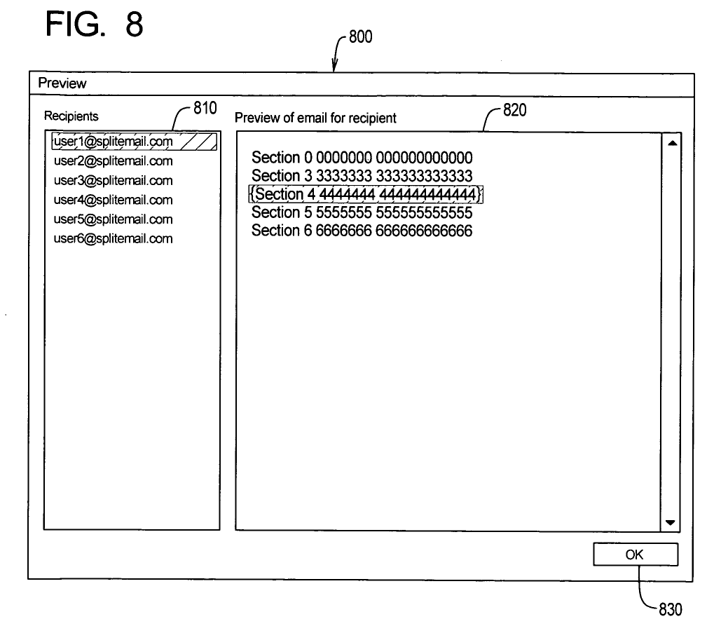

From the email editor window 600, the author has the option to select any of the icons shown in the email editor toolbar 330. For example, the author can mark additional information private by selecting the Mark Private icon 340. Furthermore, by selecting the Preview icon 370, the author can preview the content of the messages to be sent to each recipient, as will be explained in connection with FIGS. 8-13.

After the author has selected the Preview icon 370, a preview window 800 (shown in FIG. 8) will open for a recipient. In FIG. 8, preview window 800 has been opened for User1 (by default).

Preview window 800 includes a recipient box 810 and a preview email box 820. The recipient box 810 includes a lists all of the recipients and is populated by the email header information 310 entered by the author (see FIG. 3). The preview email box 820 includes a preview of the body of the email message that would be received by a selected recipient if the email message was sent. Advantageously, before the message is sent, the author is given the opportunity verify that the content of the message is acceptable for the selected recipient.

In one embodiment, if the author finds that the content of the message for a selected recipient is not acceptable, the author may make modifications to the message in the preview email box 820. In such case, the modifications will be carried through to the email editor window 600. That is, non-private information will be changed for all recipients, private information will be changed for the particular recipients for which such private information is intended, and highlighted information will be changed for the particular recipients for which such highlighted information is intended.

In one embodiment, if the author finds that the content of the message for a selected recipient is not acceptable, the author selects the OK icon 830 and is returned to the email editor window 600 (see FIG. 6). From there, the author may select the appropriate icon(s) in the email editor toolbar 330 to change the content of the message for a particular recipient or groups of recipients.

In one embodiment, once the preview window 800 has been opened, the author can preview email messages intended for each recipient without having to select the Preview icon 370 (shown in FIG. 6) each time an email message is to be previewed. For example, the author can preview the email message for User1 (see FIG. 8). Then, without having to select the OK button 830, the author can select User2 from the list of recipients in the recipient box 810 to preview the email message that will be sent to User2. Accordingly, the author can affectively “toggle” between the various recipients to preview their email messages, all without having to select the Preview icon 370 multiple times.

FIG. 8 illustrates a preview window 800, wherein User1 has been selected in the recipient box 810 (in this case by default) and a preview of the email message to be sent to User1 is shown in the preview email box 820. With reference to FIGS. 2 and 6, preview email box 820 correctly shows that User1 will receive the Section 0 non-private information, the Section 3 non-private information, a privately-highlighted version of the Section 4 non-private information (surrounded by identifying indicia in the form of an open bracket and a closed bracket), the Section 5 non-private information and the Section 6 non-private information. User1 will not receive the Section 1 and Section 2 private information.

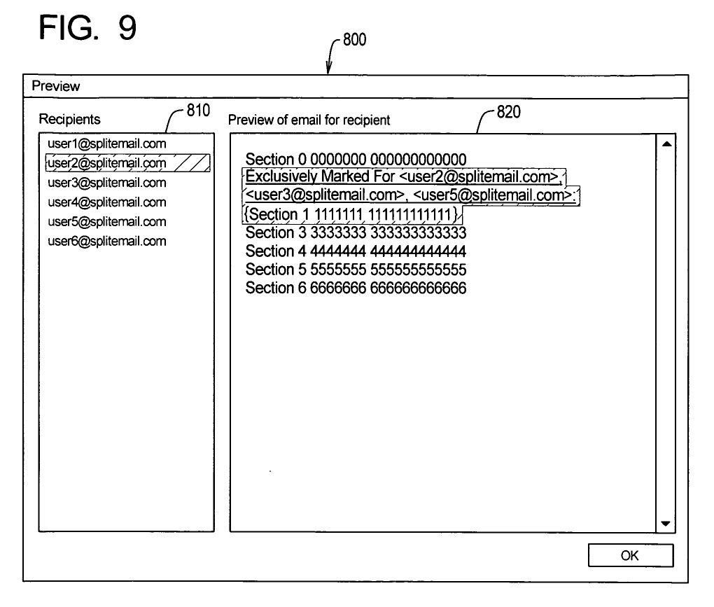

FIG. 9 illustrates a preview window 800, wherein User2 has been selected in the recipient box 810 and a preview of the email message to be sent to User2 is shown in the preview email box 820. With reference to FIGS. 2 and 6, preview email box 820 correctly shows that User2 will receive the Section 0 non-private information, the Section 1 private information, the Section 3 non-private information, the Section 4 non-private information, the Section 5 non-private information and the Section 6 non-private information. User2 will not receive any Section 2 private information. Furthermore, FIG. 9 shows that the language “Exclusively Marked For <user2@splitemail.com>, <user3@splitemail.com>, <user5@splitemail.com>:” will appear before the actual text of Section 1, so that User2 will be informed of the other non-confidential recipients who will be receiving the Section 1 private information. The Section 1 text is also surrounded by identifying indicia in the form of an open bracket and a closed bracket.

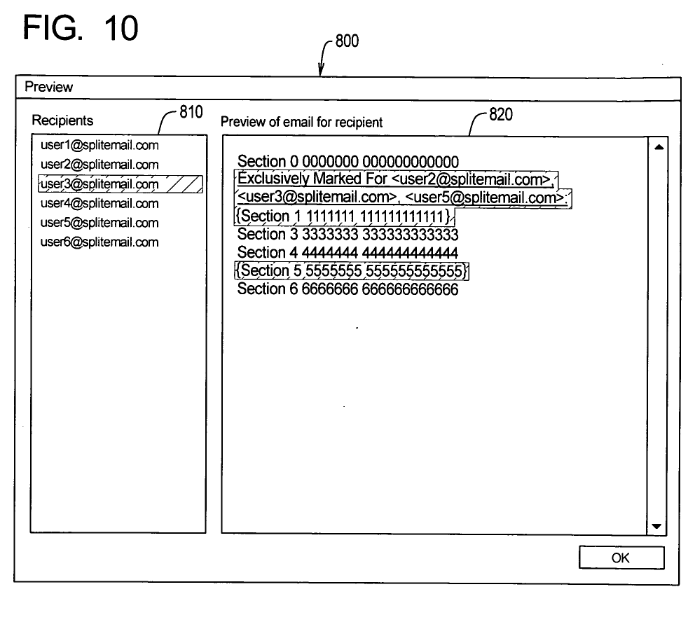

FIG. 10 illustrates a preview window 800, wherein User3 has been selected in the recipient box 810 and a preview of the email message to be sent to User3 is shown in the preview email box 820. With reference to FIGS. 2 and 6, preview email box 820 correctly shows that User3 will receive the Section 0 non-private information, the Section 1 private information, the Section 3 non-private information, the Section 4 non-private information, a privately-highlighted version of the Section 5 non-private information (surrounded by identifying indicia in the form of an open bracket and a closed bracket) and the Section 6 non-private information. User3 will not receive any Section 2 private information. Furthermore, FIG. 10 shows that the language “Exclusively Marked For <user2@splitemail.com>, <user3@splitemail.com>, <user5@splitemail.com>:” will appear before the actual text of Section 1, so that User3 will be informed of the other non-confidential recipients who will be receiving the Section1 private information. The Section 1 text is also surrounded by identifying indicia in the form of an open bracket and a closed bracket.

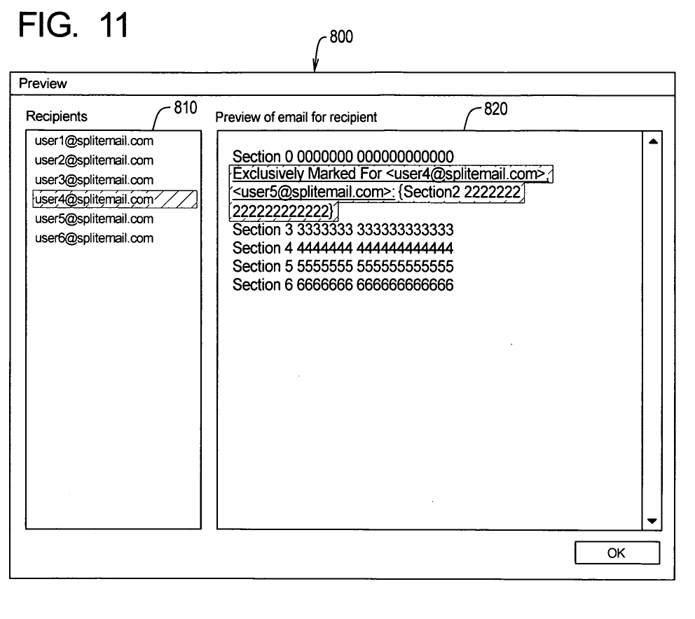

FIG. 11 illustrates a preview window 800, wherein User4 has been selected in the recipient box 810 and a preview of the email message to be sent to User4 is shown in the preview email box 820. With reference to FIGS. 2 and 6, preview email box 820 correctly shows that User4 will receive the Section 0 non-private information, the Section 2 private information, the Section 3 non-private information, the Section 4 non-private information, the Section 5 non-private information and the Section 6 non-private information. User4 will not receive any Section 1 private information. Furthermore, FIG. 11 shows that the language “Exclusively Marked For <user4@splitemail.com>, <user5@splitemail.com>:” will appear before the actual text of Section 2, so that User4 will be informed of the other non-confidential recipients who will be receiving the Section 2 private information. Notably, “<user6@splitemail.com>” does not appear before the actual text of Section 2, since User6 is a confidential recipient (i.e., a Bcc: recipient). The Section 2 text is also surrounded by identifying indicia in the form of an open bracket and a closed bracket.

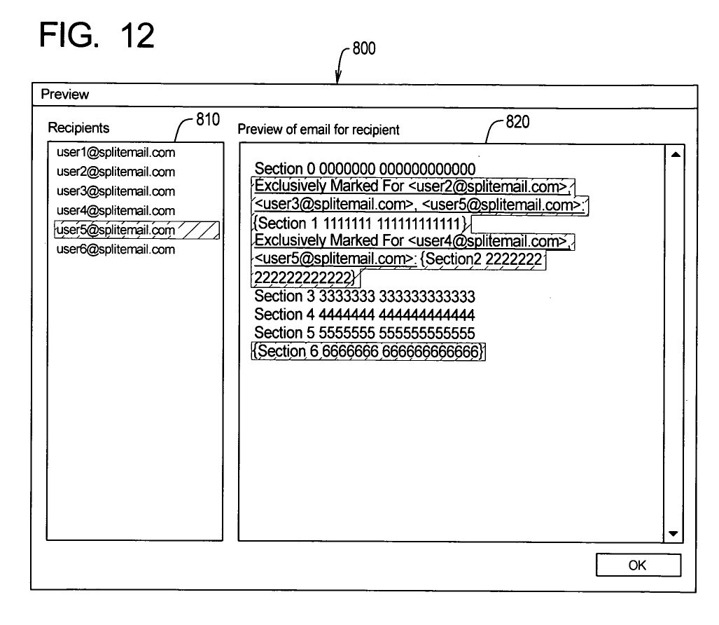

FIG. 12 illustrates a preview window 800, wherein User5 has been selected in the recipient box 810 and a preview of the email message to be sent to User5 is shown in the preview email box 820. With reference to FIGS. 2 and 6, preview email box 820 correctly shows that User5 will receive the Section 0 non-private information, the Section 1 private information, the Section 2 private information, the Section 3 non-private information, the Section 4 non-private information, the Section 5 non-private information and a privately-highlighted version of the Section 6 non-private information (surrounded by identifying indicia in the form of an open bracket and a closed bracket). Furthermore, FIG. 12 shows that the language “Exclusively Marked For <user2@splitemail.com>, <user3@splitemail.com>, <user5@splitemail.com>:” will appear before the actual text of Section 1, so that User5 will be informed of the other non-confidential recipients who will be receiving the Section 1 private information. In addition, FIG. 12 shows that the language “Exclusively Marked For <user4@splitemail.com>, <user5@splitemail.com>:” will appear before the actual text of Section 2, so that User5 will be informed of the other non-confidential recipients who will be receiving the Section 2 private information. Notably, “<user6@splitemail.com>” does not appear before the actual text of Section 2, since User6 is a confidential recipient (i.e., a Bcc: recipient). In addition, both the Section 1 text and the Section 2 text are surrounded by identifying indicia in the form of an open bracket and a closed bracket.

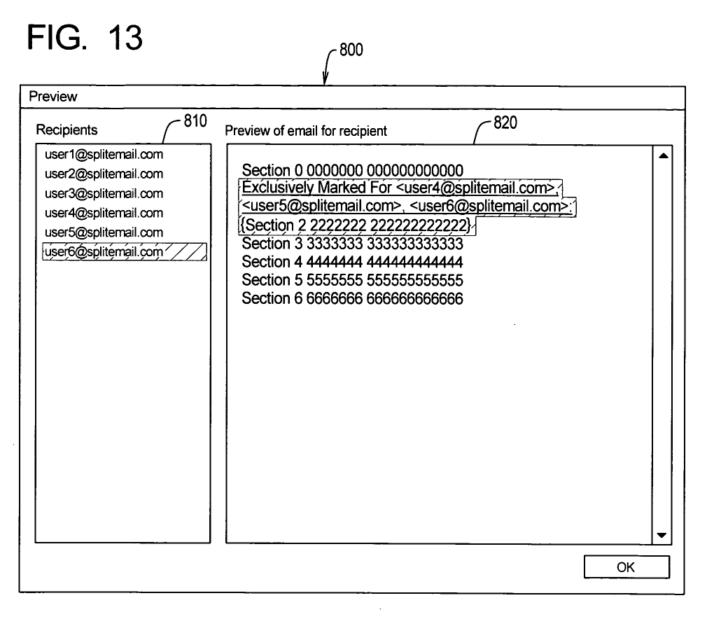

FIG. 13 illustrates a preview window 800, wherein User6 has been selected in the recipient box 810 and a preview of the email message to be sent to User6 is shown in the preview email box 820. With reference to FIGS. 2 and 6, preview email box 820 correctly shows that User6 will receive the Section 0 non-private information, the Section 2 private information, the Section 3 non-private information, the Section 4 non-private information, the Section 5 non-private information and the Section 6 non-private information. User6 will not receive any Section1 private information. Furthermore, FIG. 13 shows that the language “Exclusively Marked For <user4@splitemail.com>, <user5@splitemail.com>, <user6@splitemail.com>:” will appear before the actual text of Section 2, so that User6 will be informed of the non-confidential recipients who will be receiving the Section 2 private information. In this case, “<user6@splitemail.com>” will appear before the actual text of Section 2, since FIG. 13 shows the message to be sent to User6. However, if another (e.g., User7) confidential recipient (i.e., Bcc: recipient) was to receive the Section 2 private information, then the email address for such recipient would not appear in the preview email box 820 associated with User6.

Once the author is satisfied with his message, the author selects the Send icon from the email editor toolbar 330 and separate messages are sent to each one of the recipients. In one embodiment, regardless of the number of portions of private information that are being sent to a particular recipient, the recipient will receive only one email. For example, in the example described in connection with FIGS. 2 and 6, User5 will receive only one email message, even though User5 is grouped with User2 and User3 in connection with the Section 1 private information and with User4 and User6 in connection with the Section 2 private information. In this way, recipients will not be sent email messages that are substantially duplicative, thereby limiting confusion and mailbox clutter.

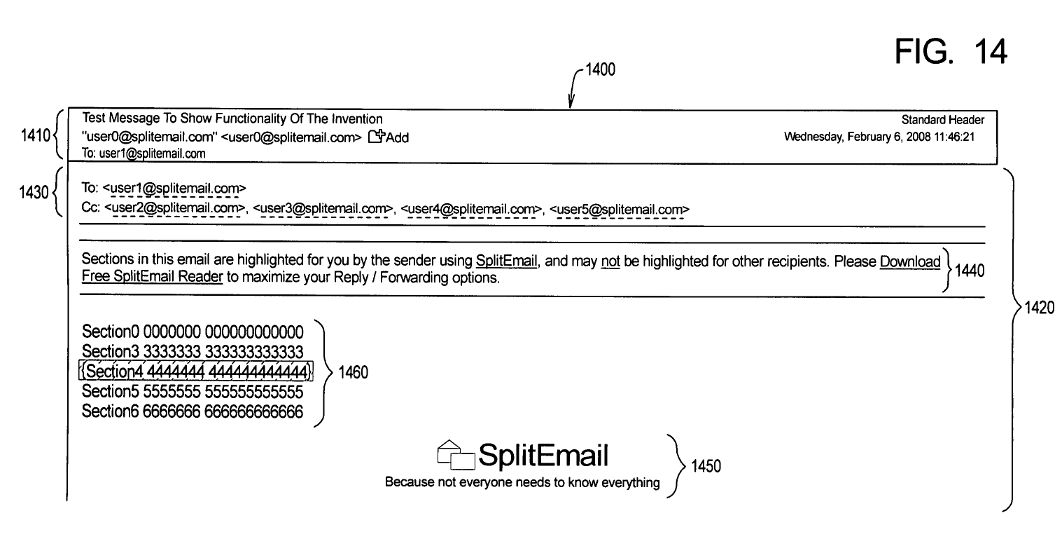

With reference to the example discussed in connection with FIGS. 2 and 6, the messages received by the recipients are shown in FIGS. 14-19. FIG. 14 illustrates a received message window 1400 for a message received by User1, wherein the received message window 1400 includes a mail header 1410 and a message body 1420. In order to ensure that private information or privately-highlighted non-private information is not accidentally forwarded by a recipient through use of a “reply to all” response, the mail header 1410 was adjusted by the SplitEmail Writer message algorithm prior to the message being sent. Accordingly, in the received message window 1400, only the email address of the author is shown in the “From:” field of the mail header 1410 and only the email address of the particular recipient (e.g., in this case, User 1) is shown in the “To:” field of the mail header 1410.

In one embodiment, except for the email address of the author (which is already included in the “From:” field of the mail header 1410), the non-confidential email addresses from the originally-composed message are placed in the message body 1420. Accordingly, the message body 1420 includes a non-confidential mail header 1430 (e.g., the language “To:” followed by the email addresses associated with the “To:” field, along with the language “Cc:” followed by the email addresses associated with the “Cc:” field). In this way, the recipient will be able to view the email addresses of the non-confidential recipients to whom the non-private information was sent.

In one embodiment, at the time of composing the original message, the author is given an option as to whether to include a non-confidential mail header 1430 or not. This could be accomplished using an icon on an email editor toolbar 330 or via a dialog box that “pops-up” on the screen before the message is sent.

One particular situation where it may be beneficial not to include a non-confidential mail header 1430 is when emails are sent as part of a large-scale marketing campaign. In such case, an email address list is “merged” with a generic email message. The present invention would allow the generic email message to include recipient-specific content, thereby tailoring the marketing process for a particular recipient or group(s) of recipients. It would also allow recipient email addresses to be excluded (or, in some cases, hidden) regardless of whether the email address was placed in the “To:” field, the “Cc:” field or the “Bcc:” field.

As shown in FIG. 14, message body 1420 may also include a message body header 1440, message body footer 1450 and main message body 1460. In one embodiment, the message body header 1440 informs the recipient that the message has been sent using SplitEmail and that it includes private information. The message body header 1440 may also include a link to a uniform reference locator (URL) that allows the recipient to download SplitEmail Reader, which provides additional options for the recipient when forwarding or replying to the message (describe further below). In addition, the message body header 1440 may include advertising information.

In one embodiment, such advertising information is content-specific advertising information. That is, the body of the email message is automatically scanned for keywords and advertising related to such keywords is placed in the message body header 1440 without human intervention.

In one embodiment, message body footer 1450 can include similar types of information to that discussed above in connection with message body header 1440. In one embodiment, some of the information discussed above is included in message body header 1440 and some of the information discussed above is included in message body footer 1450. For example, in FIG. 14, an advertisement or tagline for SplitEmail is included in message body footer 1450.

Main message body 1460 is identical in content to the information included in the preview email box 820 shown in FIG. 8, except that the formatting may be slightly different due to differences in the character length of the preview email box 820 and the character length of the received message window 1400. Such character length differences may cause the text to “wrap” at differing locations, thereby changing certain formatting. In one embodiment, there are no differences in the character length of the preview email box 820 and the character length of the received message window 1400, so that the formatting of the main message body 1460 is identical in each.

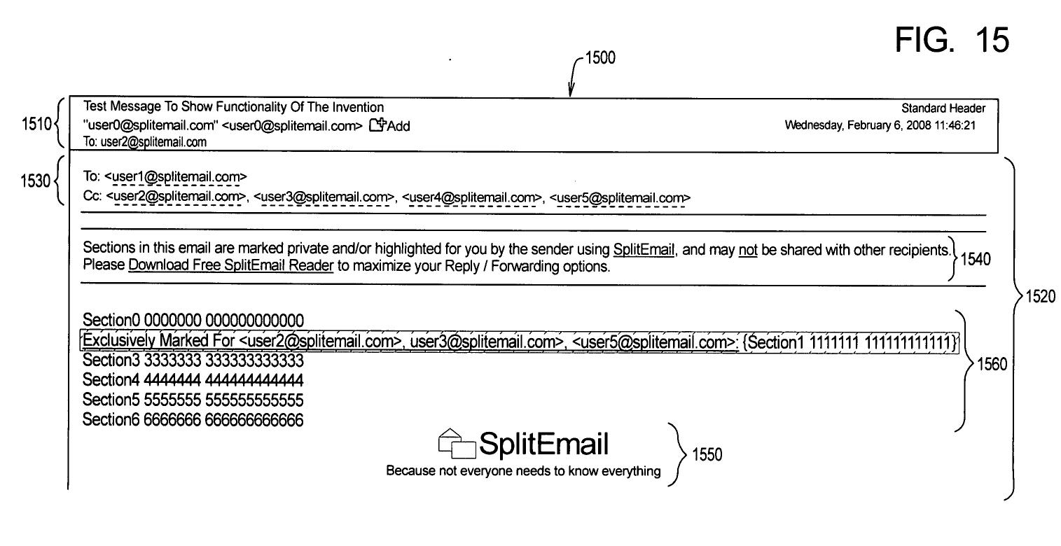

FIG. 15 illustrates a received message window 1500, mail header 1510, message body 1520, non-confidential mail headers 1530, message body header 1540, message body footer 1550 and main message body 1560, like that shown in FIG. 14. However, FIG. 15 shows an exemplary message received by User2.

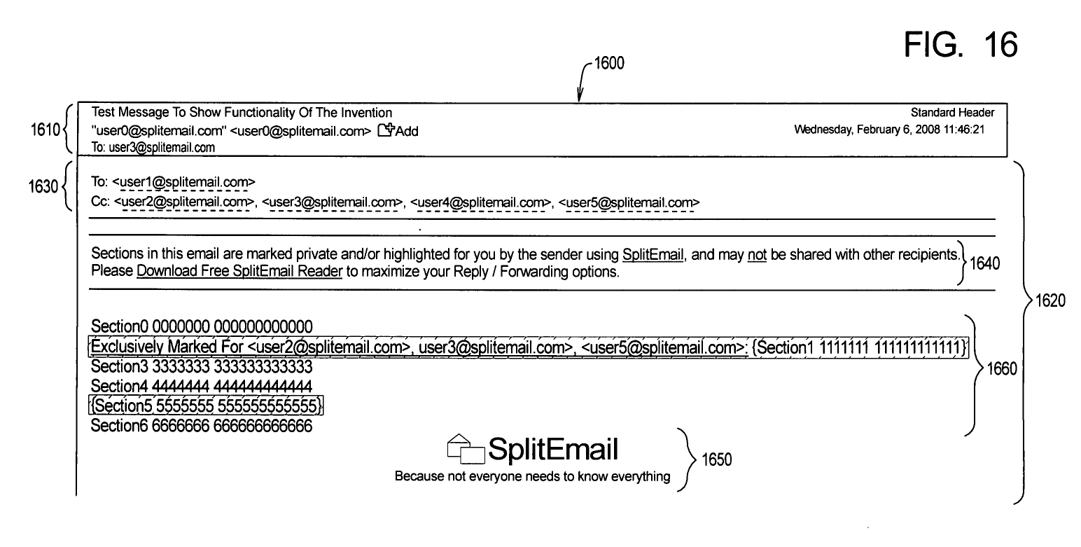

FIG. 16 illustrates a received message window 1600, mail header 1610, message body 1620, non-confidential mail headers 1630, message body header 1640, message body footer 1650 and main message body 1660, like that shown in FIG. 14. However, FIG. 16 shows an exemplary message received by User3.

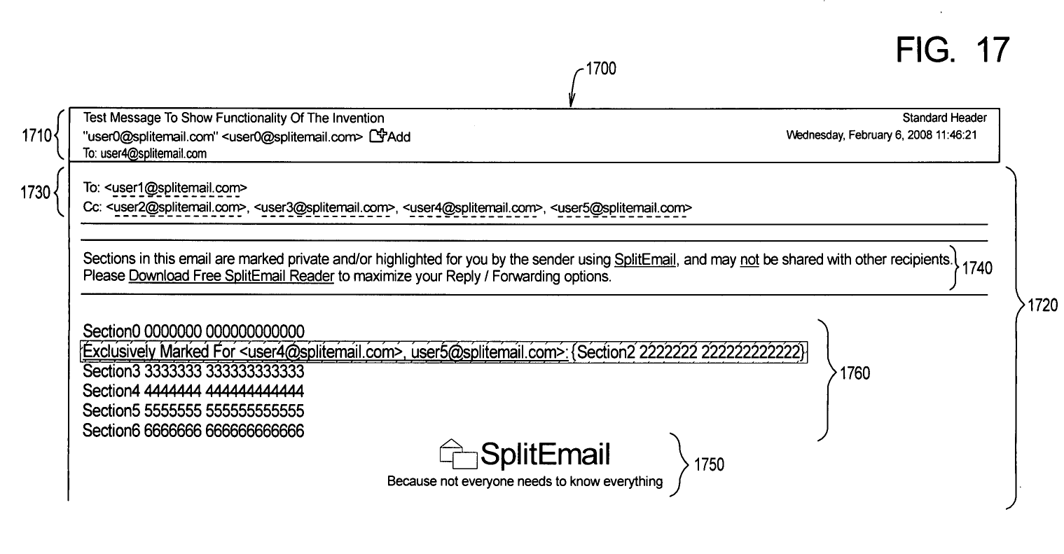

FIG. 17 illustrates a received message window 1700, mail header 1710, message body 1720, non-confidential mail headers 1730, message body header 1740, message body footer 1750 and main message body 1760, like that shown in FIG. 14. However, FIG. 17 shows an exemplary message received by User4.

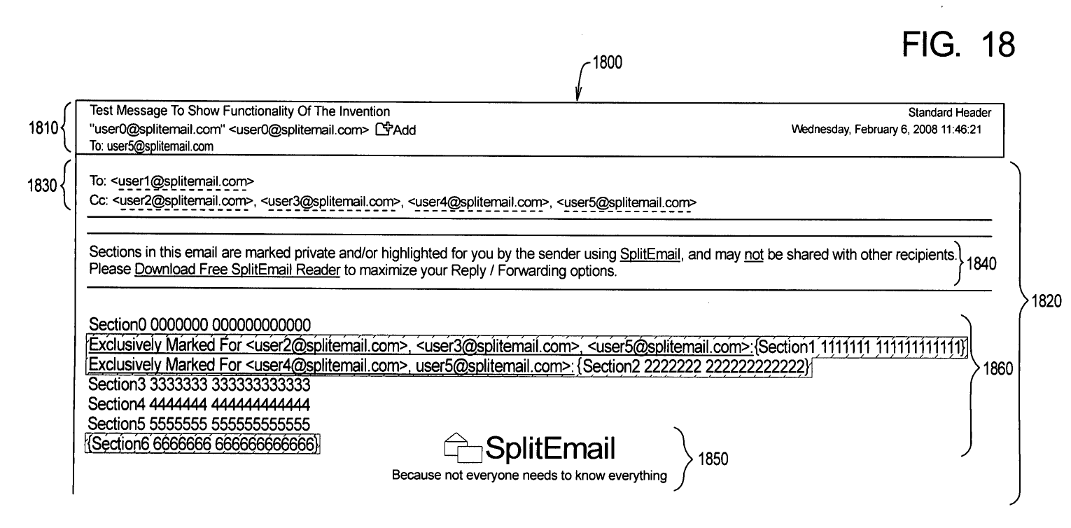

FIG. 18 illustrates a received message window 1800, mail header 1810, message body 1820, non-confidential mail headers 1830, message body header 1840, message body footer 1850 and main message body 1860, like that shown in FIG. 14. However, FIG. 18 shows an exemplary message received by User5.

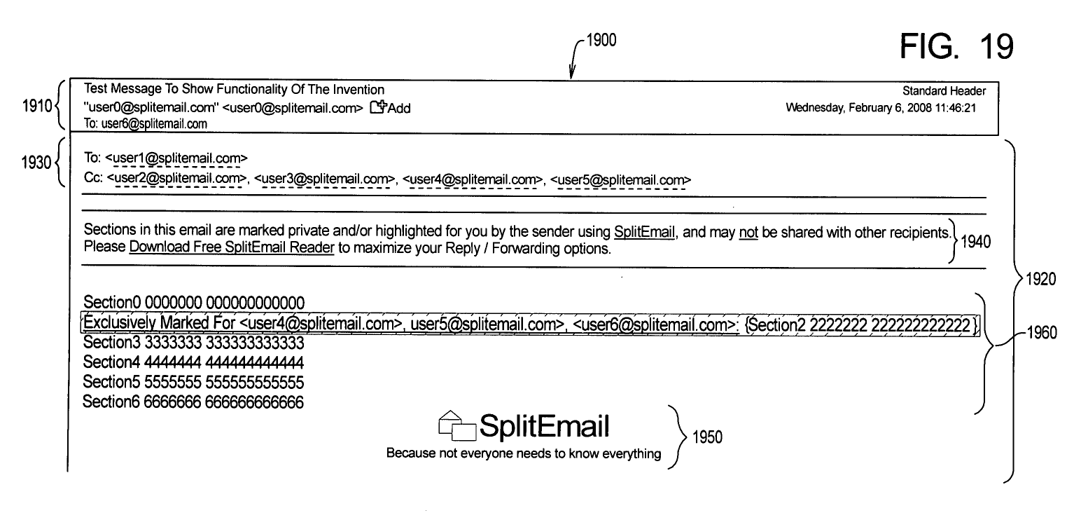

FIG. 19 illustrates a received message window 1900, mail header 1910, message body 1920, non-confidential mail headers 1930, message body header 1940, message body footer 1950 and main message body 1960, like that shown in FIG. 14. However, FIG. 19 shows an exemplary message received by User6.

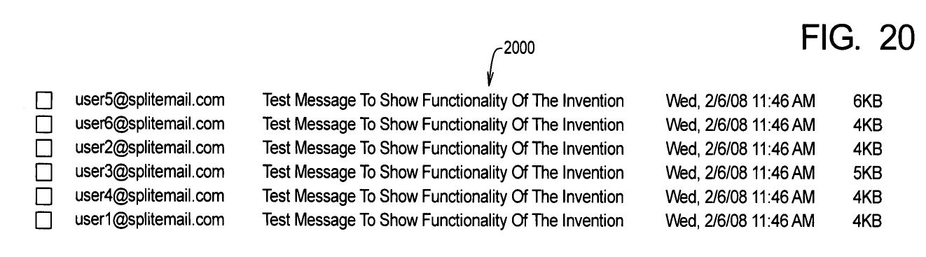

As mentioned above, using the SplitEmail message processing algorithm, a separate message is generated for each recipient. Accordingly, the author's sent messages folder includes a copy of each of the messages that were sent to the recipients. With reference to the example discussed in connection with FIGS. 2 and 6, FIG. 20 illustrates a portion of the author's sent messages folder 2000, which lists the email messages sent to the recipients.

As shown, for example, in FIG. 14, once a recipient has received a message sent using the SplitEmail Writer mail processing algorithm, the recipient is requested to download an optional reader called SplitEmail Reader. It should be understood that SplitEmail Writer may be used beneficially in the absence of using SplitEmail Reader. For example, some embodiments of the invention include SplitEmail Writer downloaded on the client machine used by the author, without SplitEmail Reader being downloaded on the client machine used by the recipient.

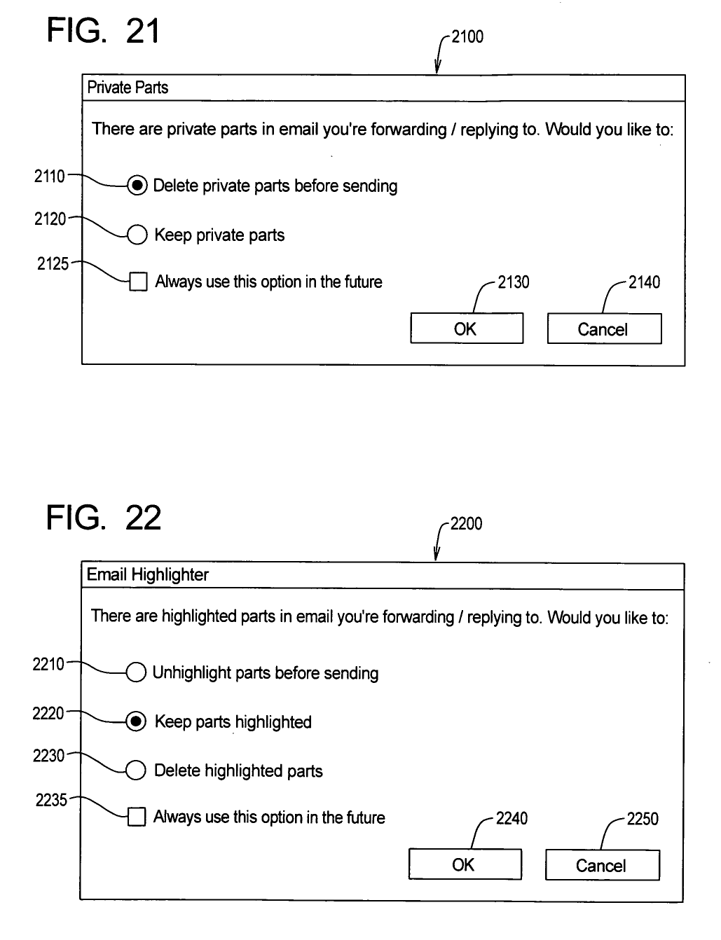

In one embodiment, if SplitEmail Reader is installed on the client machine 30 being used by the recipient, the SplitEmail Reader mail processing algorithm will issue a warning to the recipient if the recipient tries to forward or reply-to an email message that includes private information. FIG. 21 illustrates a warning dialog box 2100 that may be used to warn a recipient that is trying to forward or reply-to an email message that includes private information.

In FIG. 21, the recipient is given the option to: (1) delete the private information before forwarding or replying-to the message by selecting radio button 2110; or, (2) keep the private information when forwarding or replying-to the message by selecting radio button 2120. If the recipient selects to delete the private information before sending, the SplitEmail Reader mail processing algorithm will automatically delete such private information prior to forwarding or replying-to the message.

In one embodiment, the option to delete the private information will be the default option. In one embodiment, the option to keep the private information will be the default option. In one embodiment, a checkbox 2125 may be marked to select the appropriate option for future situations where a recipient is forwarding or replying-to an email that includes private information.

Once an option has been appropriately selected, the recipient will select the OK button 2130. If the recipient wants to cancel the process for any reason, the recipient will select the Cancel button 2140.

In one embodiment, if SplitEmail Reader is installed on the client machine 30 being used by the recipient, the SplitEmail Reader mail processing algorithm will issue a warning to the recipient if the recipient tries to forward or reply-to an email message that includes privately-highlighted non-private information. FIG. 22 illustrates a warning dialog box 2200 that may be used to warn a recipient that is trying to forward or reply-to an email message that includes privately-highlighted non-private information.

In FIG. 22, the recipient is given the option to: (1) unhighlight the privately-highlighted non-private information before forwarding or replying-to the message by selecting radio button 2210; (2) keep the privately-highlighted non-private information in highlighted form when forwarding or replying-to the message by selecting radio button 2220; or, (3) delete the privately-highlighted non-private information by selecting radio button 2230. If the recipient selects to unhighlight or delete the privately-highlighted non-private information before sending, the SplitEmail Reader mail processing algorithm will automatically accomplish same prior to forwarding or replying-to the message.

In one embodiment, the option to unhighlight the information will be the default option. In one embodiment, the option to keep the information will be the default option. In one embodiment, the option to delete the information will be the default option. In one embodiment, a checkbox 2235 may be marked to select the appropriate option for future situations where a recipient is forwarding or replying-to an email that includes privately-highlighted non-private information.

Once an option has been appropriately selected, the recipient will select the OK button 2240. If the recipient wants to cancel the process for any reason, the recipient will select the Cancel button 2250.

If the email message received by the recipient includes both private information and privately-highlighted non-private information, then the recipient may be prompted by both a warning dialog box 2100 and a warning dialog box 2200. Alternatively, a single warning dialog box (listing appropriate options) may be provided.

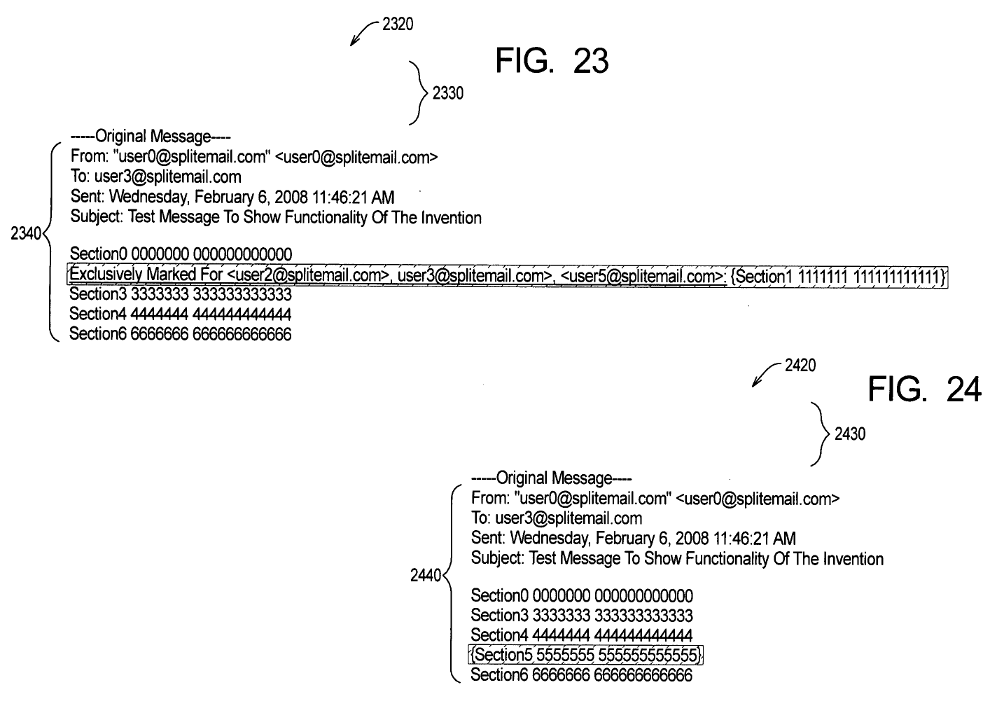

FIG. 23 illustrates a message body 2320, wherein the recipient (in this case, User3) has selected to reply-to-all recipients by including private information and deleting privately-highlighted non-private information. To more completely understand features of the SplitEmail Reader mail processing algorithm, FIG. 23 should be compared with FIG. 16.

Specifically, in FIG. 16, the mail header 1610 of the received message window 1600 was adjusted by the SplitEmail Writer mail processing algorithm prior to the message being sent, so that only the email address of the author (i.e., User0) is shown in the “From:” field of the mail header 1610 and only the email address of the particular recipient (e.g., in this case, User3) is shown in the “To:” field of the mail header 1610. Furthermore, in one embodiment, the non-confidential email addresses 1630 of the recipients of the originally-composed message were placed in the message body 1620.

Although not shown in FIG. 23, the SplitEmail Reader mail processing algorithm populates mail header with the email address of the original author in the “To:” field and the names of the original non-confidential recipients (except User3) in the “Cc:” field using the non-confidential mail headers 1630 placed in the message body 1620 and/or the original mail header 1610. Furthermore, the SplitEmail Reader mail processing algorithm does not include (or removes) the email addresses of the non-confidential recipients (except User3) in the message body 2320. That is, the original message portion 2340 of message body 2320 only shows the original author next to the language “From:” and the particular recipient (in this case, User3) next to the language “To:” (or, in one embodiment, the language “Cc:”).

In addition, the SplitEmail Reader mail processing algorithm does not include (or removes) the message body header 1640 and the.message body footer 1650 that was inserted by the SplitEmail Writer mail processing algorithm. Also, the SplitEmail Reader mail processing algorithm does not include (or removes) the privately-highlighted non-private information (in this case, Section 5 shown in FIG. 16) in the original message portion 2340. As shown in FIG. 23, the “white space” is automatically handled, in that no blank line appears where the privately-highlighted non-private information formerly appeared (i.e., there is no blank line between Section 4 and Section 6).

The recipient may compose a message in new message portion 2330 of message body 2320, when replying-to-all (or replying to the original author or forwarding the message). The SplitEmail Reader mail processing algorithm may insert a new footer or a new header that includes advertising information. In one embodiment, such advertising information is content-specific advertising information.

FIG. 24 illustrates a message body 2420, wherein the recipient (in this case, User3) has selected to reply-to-all recipients by deleting private information and keeping the privately-highlighted non-private information. To more completely understand features of the SplitEmail Reader mail processing algorithm, FIG. 24 should be compared with FIG. 16.

Specifically, in FIG. 16, the mail header 1610 of the received message window 1600 was adjusted by the SplitEmail Writer mail processing algorithm prior to the message being sent, so that only the email address of the author (i.e., UserO) is shown in the “From:” field of the mail header 1610 and only the email address of the particular recipient (e.g., in this case, User3) is shown in the “To:” field of the mail header 1610. Furthermore, in one embodiment, the non-confidential email addresses 1630 of the recipients of the originally-composed message were placed in the message body 1620.

Although not shown in FIG. 24, the SplitEmail Reader mail processing algorithm populates mail header with the email address of the original author in the “To:” field and the names of the original non-confidential recipients (except User3) in the “Cc:” field using the non-confidential mail headers 1630 placed in the message body 1620 and/or the original mail header 1610. Furthermore, the SplitEmail Reader mail processing algorithm does not include (or removes) the email addresses of the non-confidential recipients (except User3) in the message body 2420. That is, the original message portion 2440 of message body 2420 only shows the original author next to the language “From:” and the particular recipient (in this case, User3) next to the language “To:” (or, in one embodiment, the language “Cc:”).

In addition, the SplitEmail Reader mail processing algorithm does not include (or removes) the message body header 1640 and the message body footer 1650 that was inserted by the SplitEmail Writer mail processing algorithm. Also, the SplitEmail Reader mail processing algorithm does not include (or removes) the private information (in this case, Section 1 shown in FIG. 16) in the original message portion 2440. As shown in FIG. 24, the “white space” is automatically handled, in that no blank line appears where the private information formerly appeared (i.e., there is no blank line between Section 0 and Section 3).

The recipient may compose a message in new message portion 2430 of message body 2420, when replying-to-all (or replying to the original author or forwarding the message). The SplitEmail Reader mail processing algorithm may insert a new footer or a new header that includes advertising information. In one embodiment, such advertising information is content-specific advertising information.

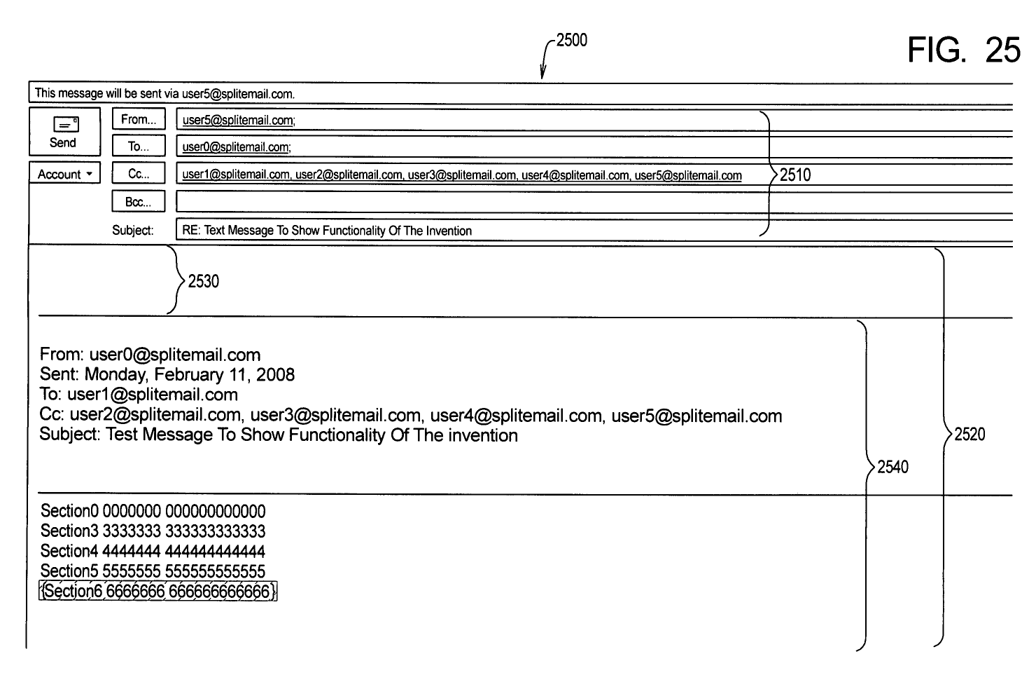

FIG. 25 illustrates an email editor window 2500, wherein the recipient (in this case, User5) has selected to reply-to-all recipients of the original email message, wherein the recipient has decided to delete the private information before the reply is sent and wherein the recipient has decided to keep privately-highlighted non-private information. To more completely understand certain features of the SplitEmail Reader mail processing algorithm, FIG. 25 should be compared with FIG. 18.

Specifically, in FIG. 18, the mail header 18 1 0 of the received message window 1800 was adjusted by the SplitEmail Writer mail processing algorithm prior to the message being sent, so that only the email address of the author is shown in the “From:” field of the mail header 1810 and only the email address of the particular recipient (e.g., in this case, User 5) is shown in the “To:” field of the mail header 1810. Furthermore, in one embodiment, the non-confidential email addresses 1830 of the recipients of the originally-composed message were placed in the message body 1820.

As shown in FIG. 25, the SplitEmail Reader mail processing algorithm populates mail header 2510 with the email address of the original author in the “To:” field and the names of the original non-confidential recipients in the “Cc:” field using the non-confidential mail headers 1830 placed in the message body 1820 and/or the original mail header 1810. Furthermore, in this embodiment, the SplitEmail Reader mail processing algorithm does not remove the email addresses of the non-confidential recipients from the message body 2520. That is, in the email editor window 2500, the original message portion 2540 of message body 2520 shows the original author next to the language “From:”, the original recipient (in this case, User1) next to the language “To:” and the original recipients of a courtesy copy (in this case, User2, User3, User4 and User5) next to the language “Cc:”.

In addition, the SplitEmail Reader mail processing algorithm does not include (or removes) the message body header 1840 and the message body footer 1850 that was inserted by the SplitEmail Writer mail processing algorithm. Also, the SplitEmail Reader mail processing algorithm does not include (or removes) the private information (in this case, both Section 1 and Section 2 shown in FIG. 18) in the original message portion 2540. As shown in FIG. 25, the “white space” is automatically handled, in that no blank line appears where the private information formerly appeared (i.e., there is no blank line between Section 0 and Section 3).

The recipient may compose a message in new message portion 2530 of message body 2520, when replying-to-all (or replying to the original author or forwarding the message). The SplitEmail Reader mail processing algorithm may insert a new footer or a new header that includes advertising information. In one embodiment, such advertising information is content-specific advertising information.

If SplitEmail Reader was not installed on the computer being used by the recipient, the recipient would not necessarily receive a warning if the recipient tried to forward or reply-to an email message that included private information. Furthermore, the recipient would not necessarily be able to automatically delete the private information, nor would the message body header and/or message body footer be automatically deleted. In addition, the recipient would not necessarily be able to automatically delete the non-confidential email addresses of the recipients of the originally-composed message that were placed in the message body. Instead, if desired, the recipient would need to manually delete the private information, the message body header and/or the message body footer, and the non-confidential email addresses placed in the message body.

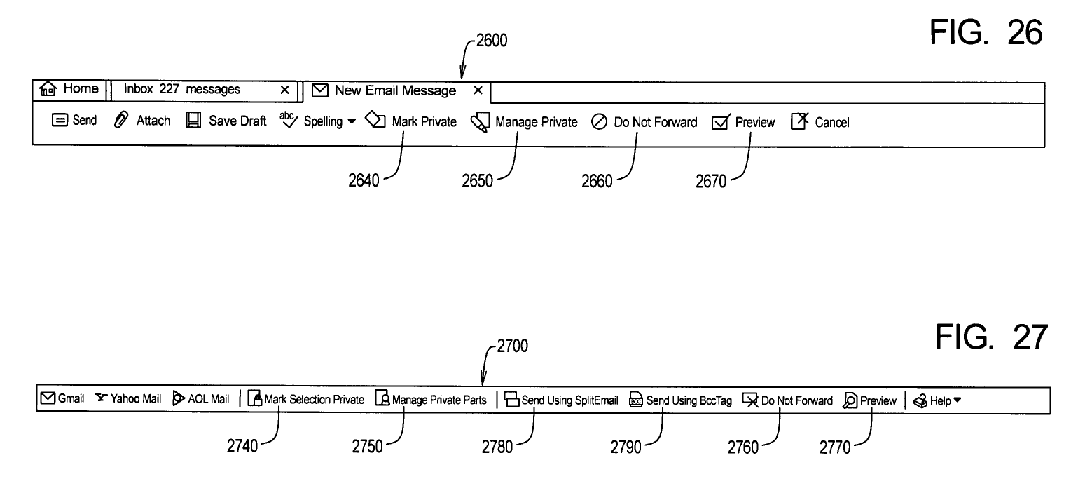

FIG. 26 illustrates a Yahoo® compose window toolbar 2600, which includes Mark Private icon 2640, Manage Private icon 2650 (instead of, or in addition to, Highlight icon), Do Not Forward icon 2660 and Preview icon 2670 seamlessly integrated therein. The Yahoog compose window toolbar 2600 also includes icons with the standard options to Send, Attach, Save Draft, check Spelling and Cancel.

FIG. 27 illustrates an Internet Explorer® toolbar 2700, which includes Mark Private icon 2740, Manage Private icon 2750 (instead of, or in addition to, Highlight icon), Do Not Forward icon 2760, Preview icon 2770, SplitEmail icon 2780 and BccTag icon 2790 seamlessly integrated therein. The Internet Explorer® toolbar 2700 also includes Gmail icon, Yahoo Mail icon, AOL Mail icon and Help icon.

### BccTag Detailed Description

In connection with describing embodiments of the BccTag message processing algorithm, reference will again be made to FIG. 2. User 0 (the author) is composing a message that is to be sent to User 1, wherein a courtesy copy is to be sent to User 2, User 3, User 4, User 5 and wherein a blind courtesy copy is to be sent to User 6. The message includes seven sections comprising Section 0, Section 1, Section 2, Section 3, Section 4, Section 5 and Section 6.

Section 0 is non-private information and is to be viewed by all recipients (i.e., User1, User2, User3, User4, User5 and User6). Section 1 is private information and is only to be viewed by User2, User3 and User5. Section 2 is private information and is only to be viewed by User4, User5 and User6. Section 3 is non-private information and is to be viewed by all recipients. Section 4 is non-private information that is to be viewed by all recipients, but is highlighted only for User1. Section 5 is non-private information that is to be viewed by all recipients, but is highlighted only for User3. Section 6 is non-private information that is to be viewed by all recipients, but is highlighted only for User5.

As shown in FIG. 3, the author (User 0) composes a message by completing email header information 310 (including the “To:”, “Cc:” and “Bcc:” sections) to the designated recipients set forth in FIG. 2. The author also completes the body of the message 320, which includes both the private information and the non-private information described in FIG. 2. The author may complete the email header information and body of the message by inputting data on the author's client machine 30 using a keyboard, a microphone, a mouse, a touchpad and/or other well-known techniques.

As shown at the top of FIG. 3, an email editor toolbar 330 includes icons with the standard options to Send, Attach, Save Draft, check Spelling and Cancel. The email editor toolbar also includes icons with the additional options to Mark Private 340, Highlight 350, Do Not Forward 360 and Preview 370, as will be described in further detail below. The exemplary additional options are seamlessly integrated into a standard email editor toolbar, after being downloaded as part of (in this case) the BccTag Writer.

In order to mark the information in Section 1 as private, the author selects the text associated with Section 1 (e.g., by depressing a mouse's left-click button at the beginning of the relevant text, dragging the mouse across the relevant text, and then releasing the mouse's left-click button). The selected text is highlighted and then the author selects the Mark Private icon 3140 from the toolbar (e.g., by depressing a mouse's left-click button while the cursor/arrow is over the Mark Private icon).

Returning to FIG. 4, a transport mode dialog box 400 for a client machine 30 is illustrated therein. Instead of selecting the SplitEmail radio button, the author chooses the BccTag radio button 420, which allows the author to send a message with recipient-specific content using a BCCTag message processing algorithm. After clicking OK 430, a Mark Private dialog box 500 will appear, as shown in FIG. 5. If the author accidentally selected the Mark Private icon 340, changed his mind or wanted to cancel the process for any other reason, the author could click Cancel 440, which would return the author to the email editor window 300.

For BccTag Writer, the manner of selecting recipients using the Mark Private dialog box 500 is virtually identical to the manner of selecting recipients described in connection with SplitEmail Writer. Accordingly, a description of same will not be provided. Instead, reference is made to FIG. 5 and its associated text. Obviously, for BccTag Writer, the list of recipients 510 is populated by the email header information 310 entered by the author (see FIG. 3).

Furthermore, the manner of managing private information and privately-highlighted non-private information is virtually identical for BccTag Writer as compared to SplitEmail Writer. Accordingly, a description of same will not be provided. Instead, reference is made to the text associated with SplitEmail Writer above (see, e.g., the text associated with FIG. 6).

For BccTag Writer, by selecting the Preview icon 370, the author can preview the content of the messages to be sent to each recipient. This is virtually identical to explanation already provided for SplitEmail Writer in connection with FIGS. 8-13. Accordingly, such description will not be repeated here. Instead, reference is made to FIGS. 8-13 and their associated descriptions.

Once the author is satisfied with his message, the author selects the Send icon from email editor toolbar 330. In one embodiment, in contrast to SplitEmail Writer, separate messages are not sent to each one of the recipients. Instead, BccTag Writer analyzes the message based upon the sections that have been associated with the various recipients. Then, using information obtained from the analysis, BccTag Writer encrypts the private information and then hides the encrypted private information before sending email messages having an identical message body to all of the recipients.

In one embodiment, recipient information associated with privately-highlighted non-private information is similarly encrypted and hidden. In such embodiment, the non-private information is not encrypted or hidden. Instead, BccTag Reader will analyze the encrypted and hidden information, so that text is highlighted for the appropriate recipients and not highlighted for other recipients. In another embodiment, both the recipient information and the privately-highlighted non-private information are encrypted and hidden.

In one embodiment, the private information is encrypted using an encryption algorithm with a specific key and a counter key, wherein the counter key is the email address of the recipient that is associated with the private information. The counter key may be obtained from the mail header or through information provided via standard email protocols (e.g., SMTP, ESMTP, IMAP or any other mail transferring protocol used by the author's email client). The encrypted private information is hidden using HTML comments or HTML tags. In one embodiment, recipient information associated with the privately-highlighted non-private information is similarly encrypted and hidden. In another embodiment, both the recipient information and the privately-highlighted non-private information are encrypted and hidden.

In one embodiment, in order for a recipient to read an email message composed using BccTag Writer, a recipient downloads software known as BCCTag Reader to the client machine 30 that recipient is using. Generally, the recipient can only view the private information if BccTag Reader is installed. If BccTag Reader is not installed, the recipient will see the non-private information but not the private information.

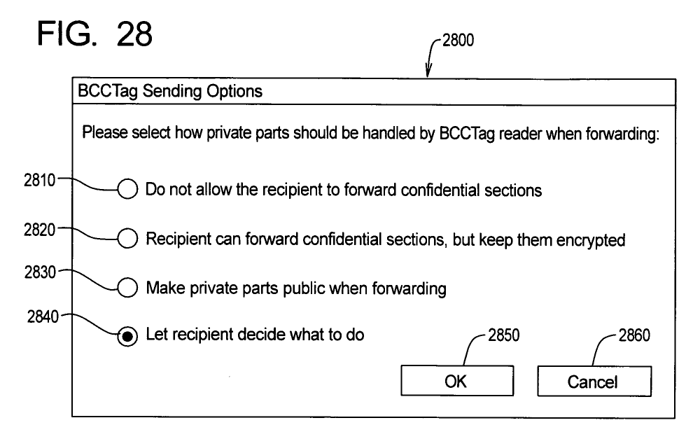

In one embodiment, BccTag Writer and BccTag Reader may be included in a single plug-in. In such case, BccTag Writer may be disabled based upon the license granted to the author or author's client machine. (It should be noted that SplitEmail Writer and SplitEmail Reader may also be included in a single plug-in and that SplitEmail Writer may be disabled based upon the license granted to the author or author's client machine.) Returning to FIG. 6, in one embodiment, after the author has decided to send the message by selecting the Send icon, a Sending Options dialog box 2800 will appear, as shown in FIG. 28. Through the Sending Options dialog box 2800, the author is given the opportunity to select one of several options as to how private information will be handled by BccTag Reader when the recipient forwards or replies-to an email message composed using BccTag Writer.

For example, if the author selected radio button 2810, the recipient would be permitted to forward or reply-to the email message (which includes private information); however, BccTag Reader (or BccTag Writer) would automatically delete one or more portions of private information (e.g., the recipient's private information and/or other encrypted private information) before the email message was forwarded or replied-to. If the author selected radio button 2820, the recipient would be allowed to forward the email message (which includes private information); however, the recipient's private information would remain encrypted, along with any other private information. If the author selected radio button 2830, the recipient would be allowed to forward or reply-to the email message (which includes private information); however, the recipient's private information would be converted into non-private information and would be viewable by the party(ies) to whom the forwarded or replied-to message is being sent. If the author selected radio button 2840, the recipient would be allowed to forward or reply-to the email message and the recipient would decide whether its private information would remain encrypted or would be converted to non-private information. In such case, the recipient may be prompted with another dialog box at the time the recipient decided to forward the message.

Once the author is satisfied with his particular selection of a radio button 2810-2840, the author selects the OK button 2850. If the author wants to cancel the process for any reason, the author selects the Cancel button 2860.

In one embodiment, the author can also optionally prevent the recipient from forwarding or replying-to the email message at all, such as by selecting Do Not Forward icon 360 from email editor toolbar 330. This is true for both BccTag Writer and for SplitEmail Writer. To deselect, the author would click on the Do Not Forward icon 360 again. Optionally, a dialog box could appear which would allow the author the opportunity to select the particular recipient (or recipients) who could not forward or reply-to the message. As another option, a dialog box could appear that would allow the author to confirm or cancel his selection regarding whether a recipient (or recipients) could forward or reply-to the message.

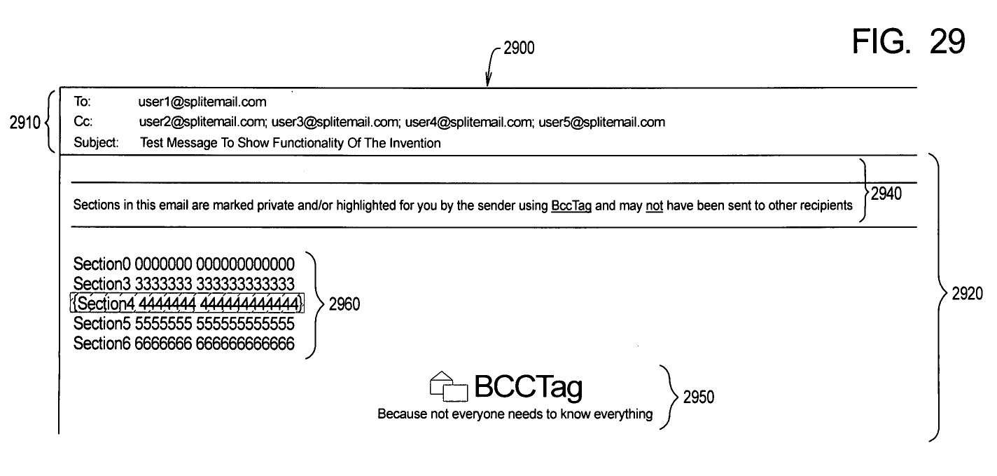

With reference to the example discussed in connection with FIGS. 2 and 6, the exemplary messages received by the recipients are shown in FIGS. 29-34. FIG. 29 illustrates a received message window 2900 for an exemplary message received by User 1, wherein the received message window 2900 includes a mail header 2910, message body 2920, message body header 2940, message body footer 2950 and main message body 2960. User1 will only view non-private information. Importantly, however, private information associated with other recipients is included in the message body 2920, but is encrypted and hidden. Cleverly, the message does not include extra “white space” associated with such private information. Specifically, there are no extra lines between the Section 1 non-private information and the Section 3 non-private information.

Furthermore, in FIG. 29, privately-highlighted non-private information for User1 appears highlighted (i.e., Section 4) and within indentifying indicia (i.e., open and closed brackets) in the message body 2920. If User1 did not receive private information or privately-highlighted non-private information, then User1 might receive a standard-looking email message without message body header 2940 or message body footer 2950.

Main message body 2960 is identical in content to the information included in the preview email box 820 shown in FIG. 8, except that the formatting may be slightly different due to differences in the character length of the preview email box 820 and the character length of the received message window 2900. Such character length differences may cause the text to “wrap” at differing locations, thereby changing certain formatting. In one embodiment, there are no differences in the character length of the preview email box 820 and the character length of the received message window 2900, so that the formatting of the main message body 2960 is identical in each.

In the embodiment shown in FIG. 29, in contrast to SplitEmail Writer, neither BccTag Writer nor BccTag Reader has moved the non-confidential recipient email addresses into the message body 2920. In another embodiment, the non-confidential recipient email addresses are placed in the message body 2920 by BccTag Writer or BccTag Reader.

In one embodiment, at the time of composing the original message, the author is given an option as to whether to include a non-confidential mail header or not. This could be accomplished using an icon on an email editor toolbar or via a dialog box that “pops-up” on the screen before the message is sent.

In FIGS. 29-34, the author's information is optionally not included in the message. That is, there is no “From:” field in the mail header. In one embodiment, a “From:” field is included in the mail header and includes author information associated therewith.

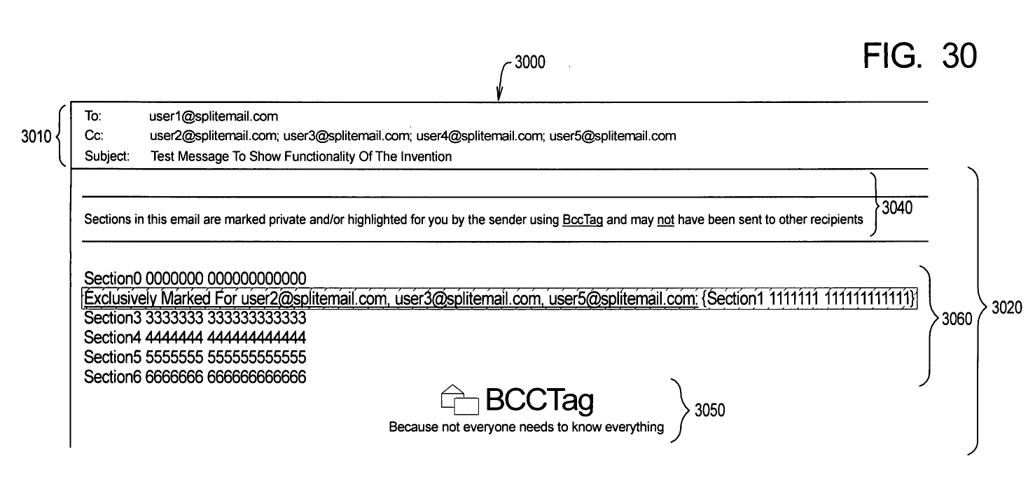

FIG. 30 illustrates an exemplary message received by User 2, which includes a received message window 3000, mail header 3010, message body 3020, message body header 3040, message body footer 3050 and main message body 3060. The mail header 3010 is similar to the mail header shown in FIG. 30.

In one embodiment, the message body header 3040 informs the recipient that the message has been sent using BccTag and that it includes private information. The message body header 3040 may also include a link to a URL that allows the recipient to download BccTag Reader, which is used to be able to decrypt the encrypted private information. In addition, the message body header 3040 may include advertising information.

In one embodiment, such advertising information is content-specific advertising information. That is, the body of the email message is automatically scanned for keywords and advertising related to such keywords is placed in the message body header 3040 without human intervention.

In one embodiment, message body footer 3050 can include similar types of information to that discussed above in connection with message body header 3040. In one embodiment, some of the information discussed above is included in message body header 3040 and some of the information discussed above is included in message body footer 3050. For example, in FIG. 30, an advertisement or tagline for BccTag is included in message body footer 3050.

Main message body 3060 is identical in content to the information included in the preview email box 820 shown in FIG. 9.

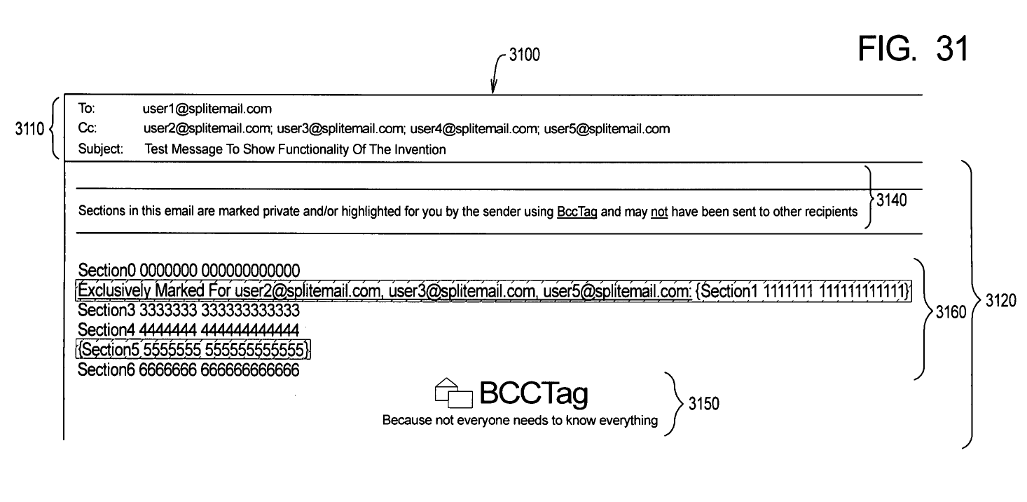

FIG. 31 illustrates a received message window 3100, mail header 3110, message body 3120, message body header 3140, message body footer 3150 and main message body 3160, like that shown in FIG. 30. However, FIG. 31 shows an exemplary message received by User3, wherein the content of the main message body 3160 is identical to the information included in preview box 820 show in FIG. 10.

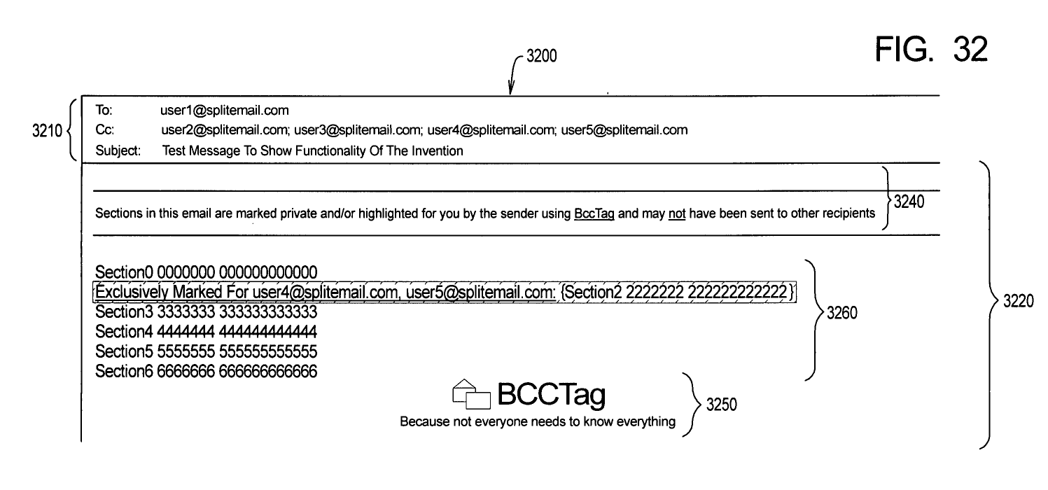

FIG. 32 illustrates a received message window 3200, mail header 3210, message body 3220, message body header 3240, message body footer 3250 and main message body 3260, like that shown in FIG. 30. However, FIG. 32 shows an exemplary message received by User4, wherein the content of the main message body 3260 is identical to the information included in preview box 820 show in FIG. 11.

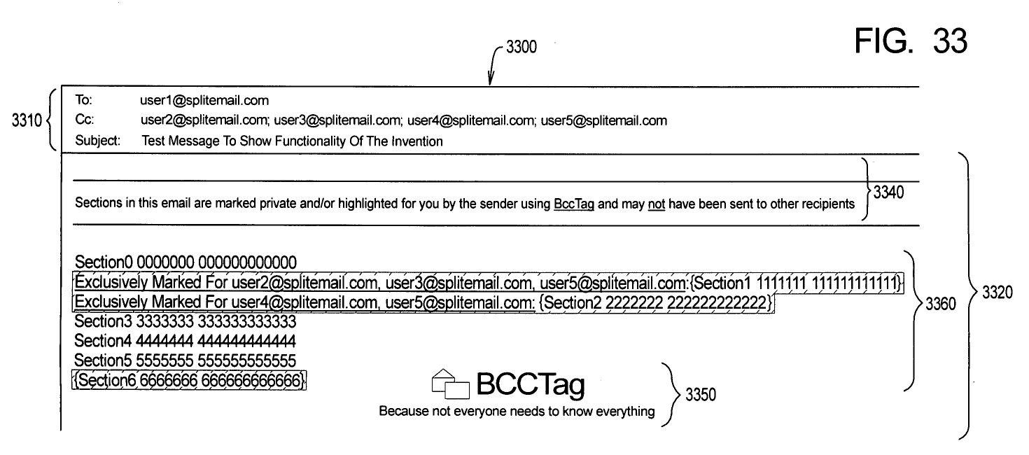

FIG. 33 illustrates a received message window 3300, mail header 3310, message body 3320, message body header 3340, message body footer 3350 and main message body 3360, like that shown in FIG. 30. However, FIG. 33 shows an exemplary message received by User5, wherein the content of the main message body 3360 is identical to the information included in preview box 820 show in FIG. 12.

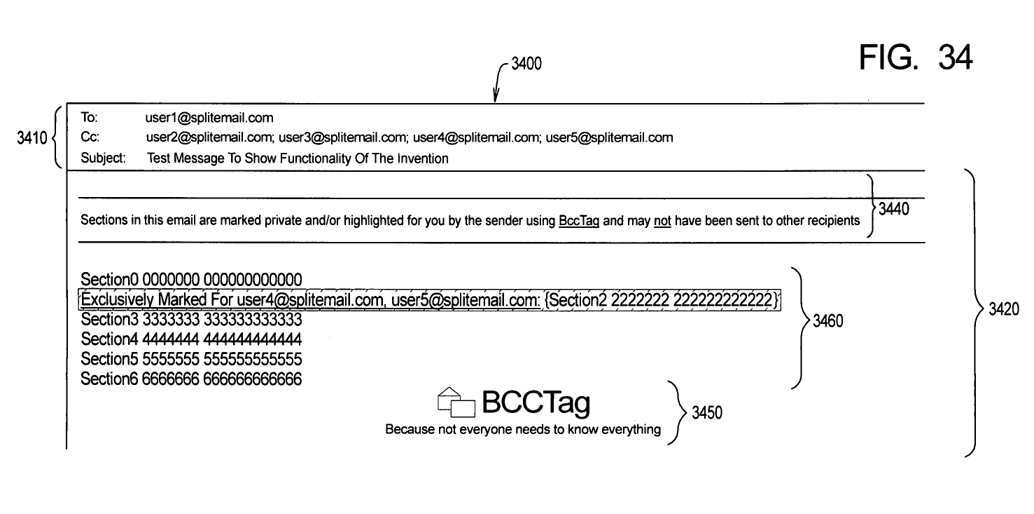

FIG. 34 illustrates a received message window 3400, mail header 3410, message body 3420, message body header 3440, message body footer 3450 and main message body 3460, like that shown in FIG. 30. However, FIG. 34 shows an exemplary message received by User6, wherein the content of the main message body 3460 is nearly identical to the information included in preview box 820 show in FIG. 13. The difference between main message body 3460 and the information included in preview box 820 is that the email address associated with User6 is optionally not shown adjacent to the Section 2 private information. In one embodiment, the email address associated with User6 is shown next to the Section 2 private information in the message received by User6, but not in the messages received by the other recipients of the Section 2 private information (i.e., User4 and User5), since User6 is a confidential recipient.

When using the BccTag message processing algorithm, a common message is sent to each recipient, but the portions of the message that are viewable to each of the recipients may be different. With reference to the example discussed in connection with FIGS. 2 and 6, FIG. 35 illustrates a portion of the author's sent messages folder 3500. The portion of the folder 3500 that shows that a common email message sent to each of the recipients is identified by reference numeral 3510, although User4, User5 and User6 do not appear due to field limitations in the sent messages folder.

In one embodiment, in order to account for circumstances where a version of BccTag Reader may not yet be available or is not easily downloadable by a client machine (e.g., in mobile telephone applications, certain Unix-based machines, Macintosh-based operating systems), a technique is required to inform the recipient that private information or privately-highlighted non-private information has been sent to the recipient and/or that the recipient needs to download BccTag Reader. In such case, as described above, BccTag Writer automatically sends the aforementioned encrypted email to all of the recipients. However, BccTag Writer also sends a second email message, in unencrypted form, which includes the private information associated with the particular recipient to whom the second email is being sent, but not the non-private information. Since the confidential text is unencrypted, it can be viewed on any email client including, for example, handhelds. The second email message also advises the recipient to download the BccTag reader to see the private information in the correct context (i.e., appropriately placed relative to the non-private information). Once the recipient has downloaded BccTag Reader, then the recipient may ignore the second email. Alternatively, BccTag Reader may automatically delete the second email.

FIG. 36 illustrates a received message window 3600 for a second email message sent to User6, which includes only the private information for User6. The received message window 3600 includes a mail header 3610 and a message body 3620. The mail header 3610 shows that the message has only been sent to User6.

The message body 3620 includes message body header 3640, message body footer 3650 and main message body 3660. In one embodiment, the message body header 3640 informs the recipient that the message has been sent using BccTag and that it includes private information. The message body header 3640 may also include a link to a URL that allows the recipient to download BccTag Reader, which is used to decrypt the encrypted private information in the “first” (or main) email message. In addition, the message body header 3640 may include advertising information.

In one embodiment, message body footer 3650 can include similar types of information to that discussed above in connection with message body header 3640. In one embodiment, some of the information discussed above is included in message body header 3640 and some of the information discussed above is included in message body footer 3650. For example, in FIG. 36, an advertisement or tagline for BccTag is included in message body footer 3650.

Main message body 3660 includes the private information for User6. In one embodiment, it may also include some language that indicates that the information is confidential (e.g., “Confidential For”, “Exclusively For” or the like) followed by the email addresses of the non-confidential recipients to whom the private information has been sent (e.g., in this case, User4, User5, User6). In one embodiment, the email addresses of such recipients are not included.

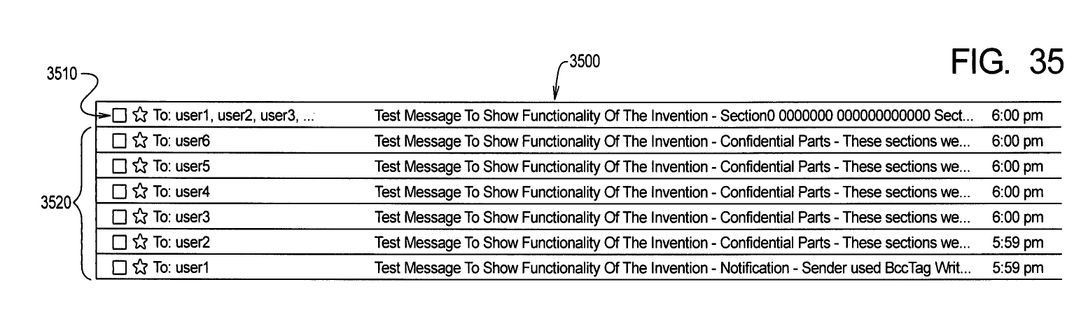

Returning to FIG. 35, the second email messages sent to User1, User2, User3, User4, User5 and User6 are identified by reference numeral 3520. Special mention must be made in connection with the second email message sent to User1.

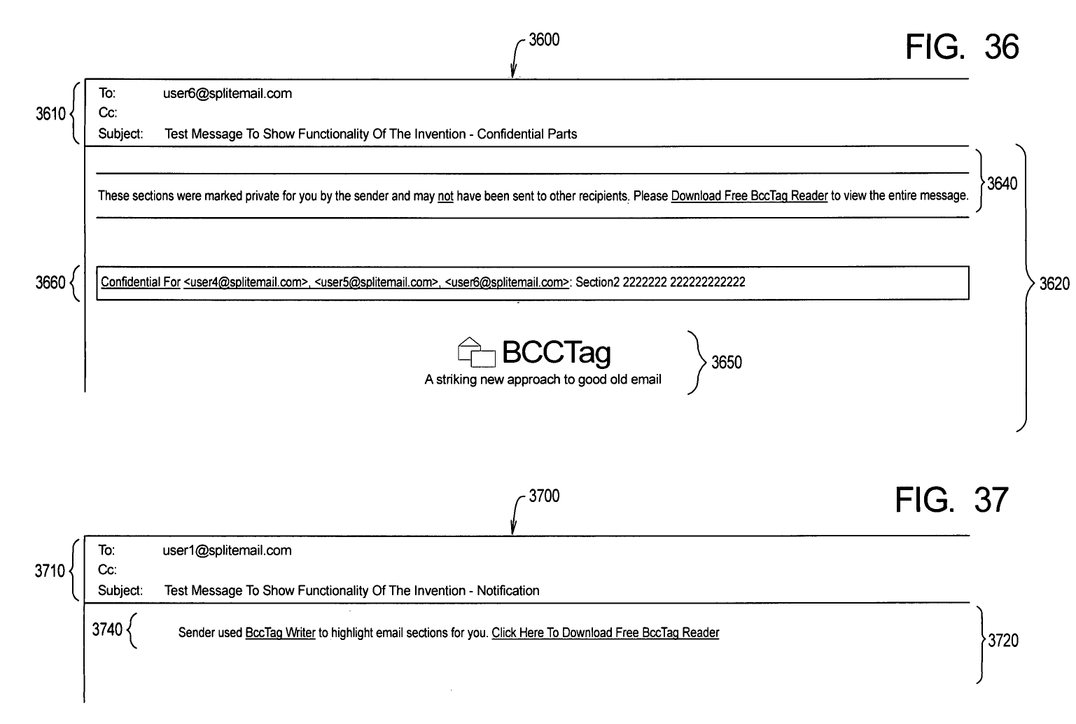

FIG. 37 illustrates a received message window 3700 for a second email message sent to User1. The received message window 3700 includes a mail header 3710 and a message body 3720. The message body 3720 includes message body header 3740 and may optionally include a message body footer (not shown).

The mail header 3710 shows that the message has only been sent to User 1. Unlike User2, User3, User4, UserS and User6, no private information will be viewable to User 1. Instead, User1 will only view non-private information and privately-highlighted non-private information. Accordingly, instead of receiving unencrypted private information like the other recipients, User1 receives a notification that the author has used BccTag Writer to highlight certain email message sections and/or a notification or link to a URL that allows the recipient to download BccTag Reader (e.g., in the message body header 3740), which is used to decrypt the encrypted privately-highlighted non-private information in the “first” (or main) email message. In addition, the message body header 3740 may include advertising information.

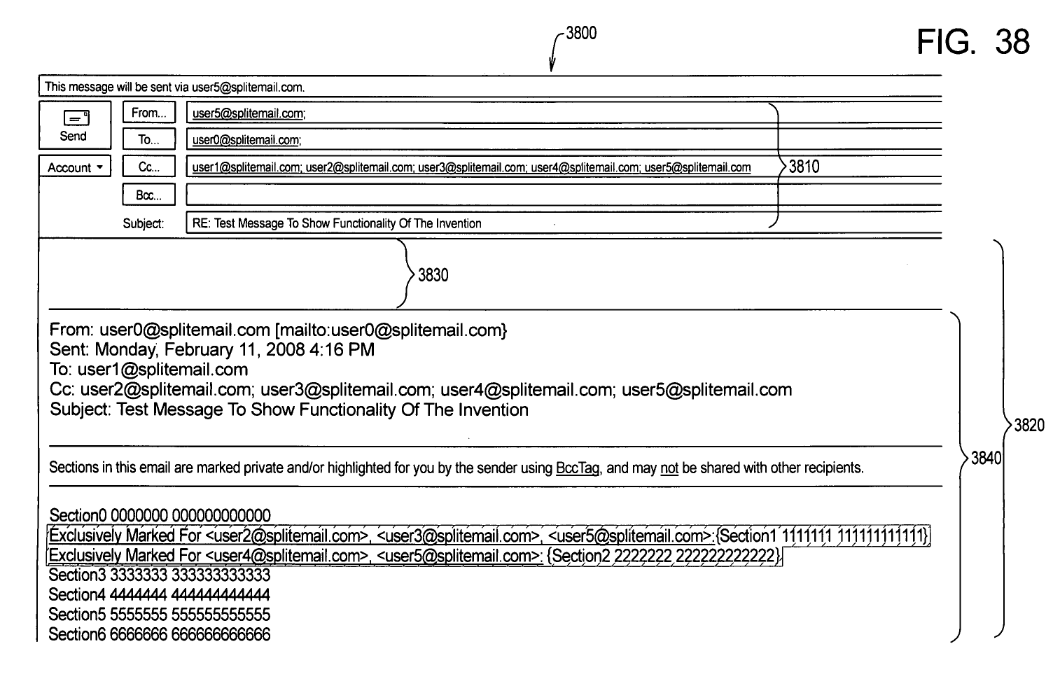

FIG. 38 illustrates an email editor window 3800, wherein the recipient (in this case, User5) has selected to reply-to-all recipients of the original email message, wherein the recipient has decided to keep the private information before the reply is sent and wherein the recipient has decided to keep the privately-highlighted non-private information, but unhighlight it. To more completely understand certain features of the BccTag Reader mail processing algorithm, FIG. 38 should be compared with FIG. 33.

In one embodiment, the BccTag Reader mail processing algorithm does not include (or removes) the message body footer 3360 that was inserted by the BccTag Writer mail processing algorithm (see FIG. 38). In one embodiment, the BccTag mail processing algorithm does not include (or removes) the message body header 3340 that was inserted by the BccTag Writer mail processing algorithm. In one embodiment, one or both of the message body header 3340 and the message body footer 3360 are included (message body header 3340 is included in FIG. 38), since BccTag Reader is generally required in order to view private information or privately-highlighted non-private information. In the present example, the BccTag Reader mail processing algorithm un-highlights the privately-highlighted non-private information (in this case, Section 6 shown in FIG. 33).

The recipient may compose a message in new message portion 3830 of message body 3820, when replying-to-all (or replying to the original author or forwarding the message). The BccTag Reader mail processing algorithm may insert a new footer or a new header that includes advertising information. In one embodiment, such advertising information is content-specific advertising information.

Several embodiments of the invention have been described above. Additional embodiments and additional description are provided below in “outline form” for a code developer.

### 1. Marking Algorithm

In order to mark text private or to highlight text, an author selects text in an email editor window and then selects a mark icon or button. The selected text is surrounded with the following HTML tags:

<INPUT type=hidden style=“width: 0; color: blue; text-decoration:
underline; border: 0; overflow-x: visible; background-color: transparent;”
value=“%TYPE% for: %RECIPIENT_EMAILS%”>
<INPUT type=hidden style=“width: 0; color: red; border: 0; overflow-x:
visible; background-color: transparent; font-weight: 800; font-size:
medium;” value={>P0 %MESSAGE%
<INPUT type=“hidden” style=“width: 0; color: red; border: 0; overflow-x:
visible; background-color: transparent; font-weight: 800; font-size:
medium;” value=}>

In this example,

% TYPE %—identifies type of the marked part (can be “Private” or “Highlighted”) % FOR %—list of recipients emails for whom the part is marked % MESSAGE %—substituted for original selected part's html
Such style of marking is selected because <INPUT type=hidden> elements are visible, but not editable in edit mode.

### 2. Parsing Draft Code

When an email is about to be sent, the application extracts the email's HTML and splits it into sequence of parts, based on the marking code described above. Each part has following properties:
Part visibility: private or public. Private parts are those marked with the template above. Public parts are the text that should be visible to everyone (e.g., adjacent to private parts).
Private part type: can be either “Private” or “Highlighted” for now. More types can be added later. For example, additional types may include: automatic translation into a different language for specific recipients; a combination of private information and highlighted information for specific recipients; different fonts, colors or typeface for specific recipients; and, any combination of the above. Private part type specifies how a part should be handled by SplitEmail/BccTag/Highlighter algorithms.
Recipients list
Part text

### 3. Creating and Sending Private Emails

After splitting the email into parts, one of the “mail processor” algorithms is called. There are two of them: SplitEmail and BccTag. They analyze marked parts and create one or more emails to send. EmailHighlighter does not have separate processor; it is handled by SplitEmail and BccTag processor, but in a different way.

### 4. SplitEmail Processor

SplitEmail creates a separate email for each recipient of original email. The mail body is composed by combining public parts with private parts that should be visible to a particular recipient. No encryption is used.

SplitEmail inserts special headers at the top of email body, which displays all To: and Cc: recipients of the original message. If Reader application is installed in recipient's mail client, the Reader application will automatically select the inserted email addresses from the email body and will use them for composing a reply-to-all message. One of the benefits of having this mechanism is that without the Reader, a recipient cannot accidentally send the private parts to everyone by accidentally replying-to-all. When the Reader is installed, the reader will warn the recipient, if the recipient is replying-to-all or forwarding private parts, as well as give the recipient a way to easily delete the private parts or portions thereof.

Technical details:

### 4.1. Private Parts

When composing SplitEmail message from original email, public parts are inserted as they are, and private ones are surrounded with special markers. These markers allow recipients to delete private parts easily when forwarding or replying-to-all. Markers are not visible and have following format:

<INPUT style=“BORDER-RIGHT: 0px; BORDER-TOP: 0px; DISPLAY:
none; OVERFLOW-X: hidden; BORDER-LEFT: 0px; WIDTH: 0px;
COLOR: white; BORDER-BOTTOM: 0px; BACKGROUND-COLOR:
transparent” type=hidden value=“--- Begin of Private
Part ---”>
%PRIVATE_PART_TEXT%
<INPUT style=“BORDER-RIGHT: 0px; BORDER-TOP: 0px; DISPLAY:
none; OVERFLOW-X: hidden; BORDER-LEFT: 0px; WIDTH: 0px;
COLOR: white; BORDER-BOTTOM: 0px; BACKGROUND-COLOR:
transparent” type=hidden value=“--- End of Private
Part ---”>

% PRIVATE_PART_TEXT % contains original private part text.
<INPUT type=hidden> is used for marking because it is invisible in mail display mode, but preserved by all of web mail interfaces when sending. In other embodiments, HTML comments, item ID's and classes may be used. However, some web mail providers currently delete such information from email messages. It is believed that they do so because such information is deemed by the webmail providers to be insignificant.

### 4.2. Highlighted Parts

The idea for highlighted parts is the same as for private parts. However, different markers and HTML templates are used:

<INPUT style=“BORDER-RIGHT: 0px; BORDER-TOP: 0px; DISPLAY:
none; OVERFLOW-X: hidden; BORDER-LEFT: 0px; WIDTH: 0px;
COLOR: white; BORDER-BOTTOM: 0px; BACKGROUND-COLOR:
transparent” type=hidden value=“--- Begin of Highlighted
Part ---”>
%HIGHLIGHTED_PART_TEXT%
<INPUT style=“BORDER-RIGHT: 0px; BORDER-TOP: 0px; DISPLAY:
none; OVERFLOW-X: hidden; BORDER-LEFT: 0px; WIDTH: 0px;
COLOR: white; BORDER-BOTTOM: 0px; BACKGROUND-COLOR:
transparent” type=hidden value=“--- End of Highlighted
Part ---”>

### 4.3. Original Recipients' Headers

These headers are inserted in the beginning of each email generated by SplitEmail. They allow a recipient to reply-to-all if the Reader application is installed.

<SPAN id=“headertostart”>To: %TO%</SPAN>
<BR>
<SPAN id=“headerccstart”>Cc: %CC%</SPAN>
<HR>

Reader application checks for these fragments in the beginning of the email body of the message being replied-to. If found, the Reader application selects the email addresses of the “Cc:” recipients from the email body and inserts them into the “Cc:” field of the email editor window, so that such addresses are included when replying-to-all.

### 4.4. Headers and Footers

When SplitEmail message is ready to be sent, its whole HTML may be surrounded with header and footer fragments.

The header and/or footer can be used to notify a recipient that the email message includes private parts and, also, to provide advertising. The header and/or footer are surrounded by special marks (e.g., HTML tags), enabling the Reader application to delete them automatically when replying in order to save email space.

<INPUT style=“BORDER-RIGHT: 0px; BORDER-TOP: 0px; DISPLAY:
none; OVERFLOW-X: hidden; BORDER-LEFT: 0px; WIDTH: 0px;
COLOR: white; BORDER-BOTTOM: 0px; BACKGROUND-COLOR:
transparent” type=hidden value=“--- Begin of Header ---”>
%HEADER/FOOTER_TEXT%
<INPUT style=“BORDER-RIGHT: 0px; BORDER-TOP: 0px; DISPLAY:
none; OVERFLOW-X: hidden; BORDER-LEFT: 0px; WIDTH: 0px;
COLOR: white; BORDER-BOTTOM: 0px; BACKGROUND-COLOR:
transparent” type=hidden value=“--- End of Header ---”>

### 5. BccTag Processor

BccTag processor works by creating one message that includes all of public and private parts and is sent to all of the original recipients at approximately the same time. Public parts are included without modification and private parts are encrypted (or encoded) and stored in the mail body along with information as to who should see them. Encrypted parts are not visible until decrypted (or decoded) by the Reader application.

In addition to the one email message with encrypted private parts described above, a separate email message is sent to any recipient for whom at least one private part was marked. These separate email messages include the private parts associated with each specific recipient and are intended for use in cases when the recipient can't install the Reader application for some reason.

### 5.1. Private Parts

Here is the format of BccTag private part:

(1) <INPUT style=“BORDER-RIGHT: 0px; BORDER-TOP: 0px; DISPLAY: none;
OVERFLOW-X: hidden; BORDER-LEFT: 0px; WIDTH: 0px; COLOR: white;
BORDER-BOTTOM: 0px; BACKGROUND-COLOR: transparent” type=hidden
value=“--- Begin of Private Part ---”>
(2) <INPUT style=“BORDER-RIGHT: 0px; BORDER-TOP: 0px; OVERFLOW-X:
hidden; BORDER-LEFT: 0px; WIDTH: 0px; COLOR: white; BORDER-BOTTOM: 0px;
BACKGROUND-COLOR: transparent” type=hidden value=“BCCTAGGED”/>
(3) <INPUT style=“BORDER-RIGHT: 0px; BORDER-TOP: 0px; OVERFLOW-X:
hidden; BORDER-LEFT: 0px; WIDTH: 0px; COLOR: white; BORDER-BOTTOM: 0px;
BACKGROUND-COLOR: transparent” type=hidden value=“%RECIPIENTS%”/>
(4) <INPUT style=“BORDER-RIGHT: 0px; BORDER-TOP: 0px; OVERFLOW-X:
hidden; BORDER-LEFT: 0px; WIDTH: 0px; COLOR: white; BORDER-BOTTOM: 0px;
BACKGROUND-COLOR: transparent” type=hidden
value=“%ENCODED_PRIVATE_PART_TEXT%”/>
(1) <INPUT style=“BORDER-RIGHT: 0px; BORDER-TOP: 0px; DISPLAY: none;
OVERFLOW-X: hidden; BORDER-LEFT: 0px; WIDTH: 0px; COLOR: white;
BORDER-BOTTOM: 0px; BACKGROUND-COLOR: transparent” type=hidden
value=“--- End of Private Part ---”>

### 5.1.1. Private Part Begin/End Markers

They work like in SplitEmail. (See section 4.1 above)

### 5.1.2. Type of BccTag Part

This identifies that the contents of the private part is encrypted with BccTag encryption. It also allows BccTag parts to be distinguished from SplitEmail or highlighted parts.

### 5.1.3. List of Recipients

List of recipients for whom the part was marked private. It is used by the Reader application to determine if it needs to decrypt a private part for particular recipient.

The string is formed as follows:

### AES_Encrypt(“FROM: % FROM % TOCC: % TOCC % BCC: % BCC %”)

% FROM %—sender's email
% TOCC %—comma-separated list of all To and Cc recipients
% BCC %—comma-separated list of all Bcc recipients
% FROM % is needed in order to make all private parts visible in sender's Sent folder, even if sender is not in To: or Cc: list
% BCC % is needed because even though some parts may be marked for Bcc-ed recipient, in decrypted email, such recipient's address should not be visible in the private part template.

### 5.1.4. Private Part Text

Just a text of private part encoded with advance encryption standard (AES) encryption. It should be noted that other encryption techniques may also be used (e.g., data encryption standard (DES), triple DES, international data encryption standard (IDEA), blowfish, RC5, XOR encryption, etc.).

### 5.2. Highlighted Parts

Privately-highlighted non-private information in BccTag is different from private information. Privately-highlighted non-private information is visible to everyone, even without the BccTag Reader application installed. However, such information is only highlighted for specific recipients.
Format of Highlighted part:

(1) <INPUT style=“BORDER-RIGHT: 0px; BORDER-TOP: 0px; DISPLAY: none;
OVERFLOW-X: hidden; BORDER-LEFT: 0px; WIDTH: 0px; COLOR: white;
BORDER-BOTTOM: 0px; BACKGROUND-COLOR: transparent” type=hidden
value=“--- Begin of Highlighted Part ---”>
(2) <INPUT style=“BORDER-RIGHT: 0px; BORDER-TOP: 0px; OVERFLOW-X:
hidden; BORDER-LEFT: 0px; WIDTH: 0px; COLOR: white; BORDER-BOTTOM: 0px;
BACKGROUND-COLOR: transparent” type=hidden value=“HIGHLIGHTED”/>
(3) <INPUT style=“BORDER-RIGHT: 0px; BORDER-TOP: 0px; OVERFLOW-X:
hidden; BORDER-LEFT: 0px; WIDTH: 0px; COLOR: white; BORDER-BOTTOM: 0px;
BACKGROUND-COLOR: transparent” type=hidden value=“%RECIPIENTS%”/>
(4) %PLAIN_PART_TEXT%
(1) <INPUT style=“BORDER-RIGHT: 0px; BORDER-TOP: 0px; DISPLAY: none;
OVERFLOW-X: hidden; BORDER-LEFT: 0px; WIDTH: 0px; COLOR: white;
BORDER-BOTTOM: 0px; BACKGROUND-COLOR: transparent” type=hidden
value=“--- End of Highlighted Part ---”>

### 5.2.1. HighlightedPpart Begin/End Markers

### Begin Marker:

<INPUT style=“BORDER-RIGHT: 0px; BORDER-TOP: 0px; DISPLAY:
none; OVERFLOW-X: hidden; BORDER-LEFT: 0px; WIDTH: 0px;
COLOR: white; BORDER-BOTTOM: 0px; BACKGROUND-COLOR:
transparent” type=hidden value=“--- Begin of Highlighted Part ---”>

### End Marker:

<INPUT style=“BORDER-RIGHT: 0px; BORDER-TOP: 0px; DISPLAY:
none; OVERFLOW-X: hidden; BORDER-LEFT: 0px; WIDTH: 0px;
COLOR: white; BORDER-BOTTOM: 0px; BACKGROUND-COLOR:
transparent” type=hidden value=“--- End of Highlighted Part ---”>

### 5.2.2. Type of Part—Highlighted

Type marker:

<INPUT style=“BORDER-RIGHT: 0px; BORDER-TOP: 0px;
OVERFLOW-X: hidden; BORDER-LEFT: 0px; WIDTH: 0px; COLOR:
white; BORDER-BOTTOM: 0px; BACKGROUND-COLOR:
transparent”type=hidden value=“HIGHLIGHTED”/>

### 5.2.3. List of Recipients (see 5.1.3)

Format of the recipients list tag:

<INPUT style=“BORDER-RIGHT: 0px; BORDER-TOP: 0px;
OVERFLOW-X: hidden; BORDER-LEFT: 0px; WIDTH: 0px; COLOR:
white; BORDER-BOTTOM: 0px; BACKGROUND-COLOR: transparent”
type=hidden value=“%RECIPIENTS%”/>

### 5.2.4. Part Text

Part text is inserted as it is, without any encoding and therefore it will be visible to everyone, even without the Reader application being installed.

In EmailHighlighter, the recipient can do, at least, the following at the time of replying with the Highlighted parts:

1) Include them in the message but un-highlight them.

2) Include the highlighted parts as they are.

3) Delete the highlighted parts.

### 5.3. Decoding BccTag Email

After receiving an incoming message body, BccTag extracts every private/highlighted part from it by matching the email text against the templates described above.

5.3.1. Private parts that are not for the current recipient are deleted from the mail body. 5.3.2. Private parts for the current recipient are decrypted and inserted back to the email message body.
5.3.3. Highlighted parts that are not for current recipient are just ignored by the Reader application and are displayed in unhighlighted form.
5.3.4. Highlighted parts that are intended for the current recipient are extracted and inserted back to the email message body.

### 5.4. Headers and Footers

Headers and footers are inserted in BccTag email messages just like they are in SplitEmail email messages (See section 4.4, above). They are inserted at the time of decrypting the email message, so if a recipient is only to view public parts and not private parts, the recipient's email body will not necessarily include headers and footers. Furthermore, the recipient may also not even know that encrypted private parts were forwarded to him.

### 5.5. BccTag Private Parts Handling Mode

The author of a BccTag email message can define how private parts should be handled by the Reader application when recipient tries to forward or reply-to the message. In one embodiment, there are at least four options:

5.5.1. Delete private parts automatically
5.5.2. Allow forwarding of private parts, but keep them encrypted
5.5.3. Automatically convert recipient's private parts into public parts
5.5.4. Allow recipient to decide what to do

This choice is made prior to sending the BccTag email message and is stored in the email body in following invisible tag at the end of email:

<INPUT style=“BORDER-RIGHT: 0px; BORDER-TOP: 0px;
OVERFLOW-X: hidden; BORDER-LEFT: 0px; WIDTH: 0px; COLOR:
white; BORDER-BOTTOM: 0px; BACKGROUND-COLOR: transparent”
type=hidden value=“BCCMODE:[1-4]”/>

It is extracted and used by the Reader application when recipient forwards or replies-to the message.

### 5.6. Do-Not-Forward Mode

This is a special case of the BccTag message processing algorithm in which the whole email message is marked confidential for every recipient and private parts handling mode (5.5) is automatically set to “5.5.1. Delete private parts automatically”. In this mode, the recipient is prohibited from forwarding the email message to anyone except back to the original sender.

### 5.7. Secondary Email

In addition to a main encrypted message, an additional email is sent to each recipient who has at least one private part marked for him in the main message. The additional email is used to make sure that the recipient will be able to read encrypted parts even if he can't install a reader application.

Structure of secondary email message:
5.7.1. Header (same as in SplitEmail, see Section 4.4).
5.7.2. Decrypted private parts for recipient in SplitEmail format (see Section 4.1 for details) without any public text between them.
5.7.3. Footer (same as in SplitEmail, see Section 4.4).

### 5.8. Additional Options

The following user options can be included in the BccTag and/or the SplitEmail message processing algorithms:
Do-Not-Forward, Highlight
Not include the header files
Not include the footer files
Not include the mail headers (e.g., the To: and/or CC: recipients in SplitEmail) Options will be implemented for each mode, i.e. Bcctag, SplitEmail, Do-Not-Forward, HighLight Only. The options may be implemented using a settings file (see below).

There are several configurable program options associated with the above-described message processing algorithms. The settings may be changed by editing settings.txt file in a program installation folder or via a graphical user interface. A terse description is provided below for each of the program options:

### 1. PublicSplitEmail=[0|1]

When using SplitEmail mode, send additional email containing only public parts and attachments to all of recipients. Default is off (0).

### 2. ShowotherRecipients=[0|1]

When showing private parts, this allows showing or hiding other recipients of this part. This setting is applied when sending email, not when reading. Default is ‘Show’ (1). Some users may not want others to know who else was copied on the confidential part.

### 3. EnableKeepEncrypted=[0|1]

Enable user to choose ‘Recipient can forward confidential sections, but keep them encrypted’ option when sending BccTag email (see p. I.9.b). Default is off (0) to not confuse the user.

### 4. EnableMakePublic=[0|1]

Enable user to choose ‘Make private parts public when forwarding’ option when sending BccTag email (see p. I.9.c). Default is off (0).

5. bcctag.highlight.notification=[0|1]
Enable to send separate notification email with prompt to download Reader in case when sending highlighted parts only but using BccTag algorithm. Default is on (1).
6. bcctag.noforward.notification=[0|1]
Enable to send separate notification email with prompt to download Reader in case when sending with option ‘Do not allow the recipient to forward confidential sections’ and using BccTag algorithm. Default is on (1).
7. bcctag.private.header=[0|1]
8. bcctag.private.footer=[0|1]
Enable or disable header/footer in additional BccTag emails with private parts only. Both options are enabled by default and take effect when sending email.
9. bcctag.shared.header=[0|1]
10. bcctag.shared.footer=[0|1 ]
Enable or disable header/footer in common BccTag email, when there are only private parts in it. Both options are enabled by default and take effect for incoming mail.
11. bcctag.common.header=[0|1]
12. bcctag.common.footer=[0|1]
Enable or disable header/footer in common BccTag email, when there are both private and highlighted parts in it. Both options are enabled by default and take effect for incoming mail.
13. bcctag.highlight.header=[0|1]
14. bcctag.highlight.footer=[0|1]
Enable or disable header/footer in common BccTag email, when there are only highlighted parts in it. Both options are enabled by default and take effect for incoming mail.
15. bcctag.noforward.header=[0|1]
16. bcctag.noforward.footer=[0|1]
Enable or disable header/footer in emails sent with ‘Do Not Forward’ mode. Both options are enabled by default and take effect for incoming mail.
17. bcctag.shared_noforward.header=[0|1]
18. bcctag.shared_noforward.footer=[0|1]
Enable or disable informational header/footer in emails sent with ‘Do Not Forward’ mode. Informational headers are visible if recipient don't have reader installed and used to inform him about encoded content and prompt to download reader. Both options are enabled by default and take effect at the time of sending.
19. splitemail.private.header=[0|1]
20. splitemail.private.footer=[0|1 ]
Enable or disable header/footer SplitEmail message, when there are only private parts in it. Both options are enabled by default and take effect when sending.
21. splitemail.highlight.header=[0|1]
22. splitemail.highlight.footer=[0|1]
Enable or disable header/footer SplitEmail message, when there are only highlighted parts in it. Both options are enabled by default and take effect when sending.
23. splitemail.common.header=[0|1]
24. splitemail .common.footer=[0|1]
Enable or disable header/footer SplitEmail message, when there are both highlighted and private parts in it. Both options are enabled by default and take effect when sending.
25. splitemail.mailheaders=[0|1]
Enable or disable additional SplitEmail headers (To: and Cc:) required for Reply-To-All feature. Option is enabled by default and takes effect when sending.

It should be understood that the concepts described in connection with one embodiment of the invention may be combined with the concepts described in connection with another embodiment (or other embodiments) of the invention.

In one embodiment, any one or more of SplitEmail Reader, SplitEmail Writer, BccTag Reader and/or BccTag Writer may be built into an email client. In such case, separate downloading of the built-in software may not be required (except, for example, to receive updates). Furthermore, in one embodiment, a web browser and/or email client may have sufficient intelligence to decipher the tags or comments associated with the recipient-specific information.

It should be understood that the present invention is not limited to recipient-specific email messages. For example, the present invention may be used in conjunction with other applications, such as Facebook Wall. In such case, a single message would be written by an author, but not all recipients would be able to view the entirety of what was written. That is, the written information would be recipient specific.

In one embodiment, messages sent via SMS are encrypted. Such messages could only be decrypted upon entry of an appropriate password. In one embodiment, only certain private portions would be encrypted, while other portions would be viewable without entry of a password.

In one embodiment, the above-described settings file may be used to develop an email customizer. For example, when sending email messages using a mail merge type system, the settings could be selected to send more “personalized” messages without having to compose individual messages. In such case, the language “Private for:” and its associated text would not be included. In one embodiment, the SplitEmail algorithm is used to generate separate email messages for the recipients.

In one embodiment, the present invention can be extended to marketing web pages. For example, the first time that a website is visited, first information is highlighted. The next time that the website is visited, second information is highlighted. The number of visits may be tracked through use of “cookies” or entry of user information.

The present invention may be extended to include recipient-specific attachments. In such case, a dialog box similar to that shown in FIG. 7 may be used to select the appropriate recipients for a particular attachment.

It should be understood that the present invention may also be used in conjunction with a variety of document types and formats. In one embodiment, information may be made visible to specific recipients of a PDF document or a Word document based on certain criterion being met. For example, an author may wish to send a document to certain recipients, wherein the document has certain sections that are highlighted or otherwise made visible only to specific recipients. Based on the receipt of a password or an alternative authentication technique, such sections would be appropriately displayed for the specific recipients. In one embodiment, the sections are hidden from the other recipients.

With respect to the handling of “white space” in BccTag, it is handled using the INPUT type=hidden tags. The encrypted portion is simply hidden, and hence the white space issue does not arise when viewing. At the time of replying, private information for a subsequent recipient is decoded and inserted as plain text. Private information that is not to be visible to the subsequent recipient is deleted.

While an effort has been made to describe some alternatives to the preferred embodiment, other alternatives will readily come to mind to those skilled in the art. Therefore, it should be understood that the invention may be embodied in other specific forms without departing from the spirit or central characteristics thereof. The present examples and embodiments, therefore, are to be considered in all respects as illustrative and not restrictive, and the invention is not intended to be limited to the details given herein.

What is claimed is:

1. A method comprising the steps of:
composing an electronic message that includes non-private information to be viewed by multiple recipients and private information to be viewed by at least one recipient, wherein less than all of the recipients are to view the private information and wherein the message is composed by an author;
restricting a recipient of the private information from either forwarding or replying-to the message.

2. The method of claim 1, wherein the recipient is restricted from forwarding or replying-to the message in the absence of responding to a computer-generated warning that reminds the recipient that the message includes private information.

3. The method of claim 2, further comprising the step of:
in response to the computer-generated warning, selecting whether to delete the private information or whether to include the private information when forwarding or replying-to the message.

4. The method of claim 3, further including the step of:
automatically deleting the private information if the recipient selects that the private information is to be deleted when forwarding or replying-to the message.

5. The method of claim 1, wherein the electronic message includes message address headers, which identify the author's address and the addresses of one or more recipients and wherein the method includes the step of:
moving non-confidential message address headers into a message body.

6. The method of claim 5 including the step of:
permitting the recipient to only send a reply to the author's address.

7. The method of claim 5 including the step of:
permitting the recipient to only send replies to the author's address and the addresses of the non-confidential recipients who have also received the private information received by the recipient.

8. A method comprising the steps of:
composing an electronic message that includes non-private information to be viewed by multiple recipients and private information to be viewed by at least one recipient, wherein the single message is composed by an author;
encrypting the private information;
sending electronic messages to all of the recipients, wherein the body of such electronic messages includes both the non-private information and the encrypted private information;
receiving an electronic message that includes both the non-private information and the private information, wherein the private information associated with a recipient is decrypted such that it is viewable by the recipient;
restricting the recipient from forwarding the message.

9. The method of claim 8, wherein the author determines how the recipient is restricted from forwarding the message.

10. The method of claim 9, wherein the author restricts the recipient from forwarding any of the private information in the message.

11. The method of claim 9, wherein the author allows the recipient to forward the private information in the message, but such private information remains encrypted.

12. The method of claim 9, wherein the author allows the recipient to forward the private information in the message and wherein the private information is made non-private when the message is forwarded.

13. The method of claim 9, wherein the author allows the recipient to decide whether to forward the private information in the message.

14. The method of claim 8, wherein the recipient is restricted from forwarding the message in the absence of responding to a computer-generated warning that reminds the recipient that the message includes private information.

15. The method of claim 14, further comprising the step of:
in response to the computer-generated warning, selecting whether to delete the private information or whether to include the private information when forwarding the message.

16. The method of claim 15, further including the step of:
automatically deleting the private information if the recipient selects that the private information is to be deleted when forwarding the message.

17. The method of claim 15, further including the step of:
automatically decrypting the private information if the recipient selects that the private information is to be included when forwarding the message.

18. A method comprising the steps of:
composing an electronic message that includes non-private information to be viewed by multiple recipients and private information to be viewed by at least one recipient, wherein less than all of the recipients are to view the private information and wherein the message is composed by an author;
associating private information with a particular recipient using hypertext markup language (HTML) tags.

19. The method of claim 18, wherein private information is hidden from a recipient not intended to view such information using HTML tags.

20. The method of claim 18, wherein private information is marked private using HTML tags.

21. The method of claim 19, wherein a message received by a recipient not intended to view private information does not include extra white space associated with hidden private information.

22. A method comprising the steps of:
composing an electronic message using software resident on a client machine used by an author, wherein the message includes non-private information for multiple recipients and private information for at least one recipient and wherein less than all of the recipients are to be sent the private information;
associating private information with a recipient;
based upon the step of associating, determining content of the message to be sent to each recipient using the software resident on the author's client machine,
wherein said step of determining occurs prior to delivery of a message to an email server.

23. The method of claim 22, wherein the step of determining is transparent to the email server.

24. The method of claim 22 further comprising the step of:
reading a message that includes private information using software resident on a client machine used by a recipient.

25. The method of claim 24, wherein the step of reading is transparent to the email server.

26. A method comprising the steps of:
composing an electronic message that includes non-private information to be viewed by multiple recipients and private information to be viewed by at least one recipient, wherein the single message is composed by an author;
associating private information with a recipient;
encrypting the private information;
sending electronic messages to the recipients, wherein the messages include both the non-private information and the encrypted private information;
automatically sending a second electronic message to the recipient with which private information has been associated, wherein the second electronic message only includes the private information.

27. The method of claim 26 further including the step of:
the recipient receiving the second electronic message, wherein the second electronic message is not encrypted.

28. The method of claim 27, wherein the second electronic message includes information regarding a reader which decrypts private information.

29. The method of claim 28 further including the steps of:
downloading the reader;
viewing an electronic message that includes both the non-private information and the private information using the reader, wherein the private information associated with the recipient is decrypted by the reader.

30. The method of claim 29, wherein the step of viewing is performed in the absence of entering a password.

31. The method of claim 26 further including the steps of:
determining whether a reader has been downloaded to a client machine being used by the recipient;
automatically deleting the second electronic message if the reader has been downloaded to the client machine being used by the recipient.

32. A method comprising the step of:
composing an electronic message that includes non-private information to be viewed by multiple recipients and privately-highlighted non-private information to be viewed by at least one recipient, wherein less than all of the recipients are to view the privately-highlighted non-private information.

33. A method comprising the steps of:
composing an electronic message that includes non-private information to be viewed by multiple recipients and private information to be viewed by at least one recipient, wherein less than all of the recipients are to view the private information and wherein the message is composed by an author;
in connection with composing the message, selecting between encrypting private information before it is sent and not encrypting private information before it is sent.

34. A method comprising the steps of:
providing a list of email addresses for mail merging;
composing an electronic message that includes a first portion of information to be viewed by a first recipient having an email address from the list and that includes a second portion of information to be viewed by a second recipient having an email address from the list, wherein the first portion of information is different from the second portion of information, wherein at least one of the first recipient or the second recipient does not receive both the first portion of information and the second portion of information;
associating the first portion of information with the first recipient using HTML tags.

35. The method of claim 34, wherein separate email messages are delivered to the first recipient and the second recipient.

36. A method comprising the steps of:
composing an electronic message that includes non-private information to be viewed by multiple recipients, a first portion of private information to be viewed by at least one group of recipients, and a second portion of private information to be viewed by at least a second group of recipients, wherein the first portion of private information is different from the second portion of private information and wherein at least one recipient is not a member of both the first group of recipients and the second group of recipients;
providing a recipient that is a member of the first group of recipients and the second group of recipients, wherein such recipient receives a single email message that includes both the first portion of private information and the second portion of private information.
